(19) United States
(12) Patent Application Publication
(10) Pub. No.: US 2025/0055521 A1
(43) Pub. Date: Feb. 13, 2025

(54) METHODS, BASEBAND UNIT SYSTEM, AGGREGATION UNIT AND RADIO UNIT OF A DISTRIBUTED BASE STATION SYSTEM FOR HANDLING DOWNLINK COMMUNICATION

(71) Applicant: Telefonaktiebolaget LM Ericsson (publ), Stockholm (SE)

(72) Inventors: Yezi Huang, Taby (SE); Chenguang Lu, Sollentuna (SE); Miguel Berg

(21) Appl. No.: 18/719,992

(22) PCT Filed: Dec. 14, 2021
(86) PCT No.: PCT/SE2021/051245

§ 371 Date: Jun. 14, 2024

(51) Int. Cl. H04B 7/06; H04B 7/0456

(52) U.S. Cl. CPC H04B 7/0617; H04B 7/0456

(57) ABSTRACT

Disclosed is a method performed by a first radio unit, RU, (140) of a distributed base station system (100), the first RU (140) comprising Ni antennas (141, 142), the distributed base station system (100) further comprising a first aggregation unit, AU, (120) connected to the first RU (140) via a first AU fronthaul, FH, link (145) and a second RU (150) connected to the first AU (120) via a second AU FH link (155), the second RU (150) comprising N₂ antennas (151, 152), the distributed base station system (100) further comprising a BBU (110) connected to the first AU (120) over a first BBU FH link (115). The method comprises obtaining a first downlink, DL, channel estimate of a communication channel between the first RU (140) and a first number of UEs (181, 182, 183), determining first intermediate beamforming weights, BFW, and sending, to the first AU (120), the determined first intermediate BFW. The method further comprises receiving, from the first AU (120), intermediately-beamformed DL data streams of first user layers of the first number of UEs (181, 182, 183), obtaining second part of BFW based on the first DL channel estimate, and beamforming the received intermediately-beamformed DL data streams of the first user layers based on the second part of BFW into beamformed DL data streams for the first user layers, or receiving, from the first AU (120), DL data streams of the first user layers and receiving first part of BFW for the first user layers, determining final BFW, and beamforming the received DL data streams of the first user layers based on the determined final BFW into beamformed DL data streams for the first user layers K₁. Thereafter, the beamformed DL data streams of the first user layers are transmitted to the first number of UEs (181, 182, 183).

### TECHNICAL FIELD

The present disclosure relates generally to methods, baseband unit system, aggregation unit and radio unit of a distributed base station for handling downlink communication. The present disclosure further relates to computer programs and carriers corresponding to the above methods, baseband unit system, aggregation unit and radio unit.

### BACKGROUND

In order to cater for the increasing demand of throughput in wireless communication networks, and especially over the air interface between a User Equipment (UE), below also called user, and a base station, aka network node, massive Multiple Input Multiple Output (MIMO) techniques have been developed.

Massive MIMO techniques have first been adopted to practice in Long Term Evolution (LTE), aka 4G. In New Radio (NR), aka 5G, it becomes one key technology component, which will be deployed in a much larger scale than in LTE. Massive MIMO techniques feature with a large number of antennas used on the base-station side, where the number of antennas is typically much larger than the number of user-layers, for example, 64 antennas serving 8 or 16 user-layers in frequency range 1 (FR1), which comprises sub-6 GHz frequency bands, and 256/512 antennas serving 2 or 4 layers in FR2, which comprises frequency bands from 24.25 GHz to 52.6 GHz. A “user layer” when used herein e.g., means an independent downlink data stream intended for one user. One user may have one or multiple user layers. Massive MIMO is also referred to as massive beamforming, which is able to form narrow beams focusing on different directions to counteract against the increased path loss at higher frequency bands. It also benefits multi-user MIMO, which allows for transmissions from/to multiple users simultaneously over separate spatial channels resolved by the massive MIMO technologies, while keeping high capacity for each user. It can also mitigate the inter-cell interferences by placing nulls in the directions of the interferences. Therefore, massive MIMO can significantly increase the spectrum efficiency and cell capacity.

A base station that handles massive MIMO techniques is often realized as a distributed base station system. In a distributed base station system, base station functionality is split between a base band unit (BBU) and a radio unit (RU). The RU is connected to the BBU via a fronthaul (FH) interface or link. The RU is connected to a plurality of antennas through which the RU wirelessly communicates with at least one UE. The BBU is in its turn connected to other base station systems or base stations, and over a backhaul interface to a core network (CN) of the wireless communication system. The BBU is centralized and there is normally more than one RU connected to each BBU. Traditionally, the BBU performs advanced radio coordination features such as joint detection, joint decoding, coordinated multi-point transmission (COMP), to increase the spectrum efficiency and network capacity, as well as baseband processing, whereas the RU performs radio frequency (RF) processing and transmission/reception of the RF processed signals.

The great benefits of massive MIMO at the air-interface also introduce new challenges at the base station side. The legacy Common Public Radio Interface (CPRI) type fronthaul link/interface transports time-domain IQ samples per antenna branch. As the number of antennas scales up in massive MIMO systems, the required capacity of the fronthaul interface also increases proportionally, as each antenna branch signal needs to be transported over the fronthaul interface, which significantly drives up the fronthaul costs. To address this challenge, the fronthaul interface evolves from CPRI to eCPRI, a packet-based fronthaul interface. In eCPRI, other functional split options between a BBU and an RU are supported, referred to as different lower-layer split (LLS) options. The basic idea is to move the frequency-domain beamforming function from the BBU to the RU so that frequency samples or data of user-layers are transported over the fronthaul interface instead of transporting IQ samples per antenna branch. Note that the frequency-domain beamforming is sometimes also referred to as precoding in the downlink (DL) direction and equalizing or pre-equalizing in the uplink (UL) direction. By sending user layer data streams instead of antenna branch streams/signals over the fronthaul interface, the required fronthaul capacity and thereby the fronthaul costs are significantly reduced, as the number of user layers is typically much fewer than the number of antennas in massive MIMO.

In the context of 5G evolution towards 6G, massive, distributed MIMO (D-MIMO) has got a lot of attentions in academia and industry. Massive D-MIMO is also referred to as cell free massive MIMO system. It is typically assumed to be based on Time Division Duplex (TDD), which considers reciprocity between UL and DL channels. The idea is to deploy a large number of distributed RUs connected to a BBU via fronthaul links. The RUs are deployed at distances. The inter-RU distance as well as the distance between RU and BBU can be short or long. FIGS. 1 and 2 show two different possible architectures for such a D-MIMO system. As shown in FIG. 1, the connection between a BBU 10 and distributed RUs 20, 30, 40 of a distributed base station system 5 can be in star topology where each RU 20, 30, 40 has a dedicated fronthaul link to the BBU 10 and occupies a dedicate BBU port. FIG. 2 shows another possible distributed base station system 5 architecture, which has a cascaded topology where the RUs 20, 30, 40 are cascade-coupled to the BBU 10. This means that the RUs 20, 30, 40 share the share fiber connection towards the BBU 10 and the same BBU port. It is also possible to have a combination of star and cascade-coupled topology. FIGS. 1 and 2 each also show a backhaul connection from the BBU 5 towards a core network 6, via a possible Central Unit (CU) 7. If a CU is used, the BBU can also be referred to as a distributed unit (DU). There is higher-layer split between the CU and the DU via an F1 interface. In this case, the CU hosts higher layers such as Radio Resource Control (RRC) and Packet Data Convergence Protocol (PDCP), and the DU hosts lower layers such as Radio Link Control (RLC), Media Access Control (MAC) and the physical layer (PHY). Also shown in FIGS. 1 and 2 are UEs 51, 52, 53, 54 that each can have a wireless connection to one or more of the RUs 20, 30, 40.

In a massive D-MIMO system, multiple UEs can be served by more than one RU simultaneously using the same time-frequency resources, where the interferences between UEs can be mitigated. Theoretically, the best performance can be achieved if the interference mitigation is done centrally at the BBU, which utilizes all antennas available of all RUs for a joint processing of all UEs and enables coherent transmission or reception. Partial mitigation is achieved if the interference mitigation is done locally at each RU, which can only use the antennas at each RU, having much fewer degrees of freedom than that with central processing at BBU.

Although interference handling at the BBU, i.e., centralized interference mitigation theoretically would give the best performance for massive D-MIMO when it comes to interference mitigation, the implementation is constrained by the fronthaul network since centralized signal processing requires huge amount of fronthaul data, e.g., user-plane signals comprising user layer data and possibly also reference signals, and control-plane signals regarding channel information and beamforming weights, to be exchanged between the BBU and the RUs, one such signal per antenna. With star-topology deployment as in FIG. 1, it would require many high-speed RU-BBU FH links, each of which connects one RU to one port of the BBU. It also means that the required number of FH ports in the BBU is the same as the number of connected RUs. When the number of connected RUs becomes massive, it would become infeasible for the BBU to have so many ports. To reduce the number of required ports, fronthaul traffic can be aggregated using an Ethernet switch or IP router. However, this would dramatically increase the required link speed of the aggregation port and the corresponding link speed of the BBU port, and therefore increase the costs. The same can be said regarding the cascaded topology of FIG. 2. In addition, the cascaded topology has an unbalanced traffic issue in that the RU-RU link closer to the BBU has higher traffic as it accumulates all traffic from/to RUs connected to it.

To elaborate more, for the BBU to conduct centralized beamforming in DL, the associated beamforming weights (BFW) need to be obtained at the BBU. If channel estimation is conducted at the respective RU, each RU will need to send its estimated channel data to the BBU via the FH link such that the BBU can get the channel data from all RUs and calculate the BFW. Let Nₗ denote the number of antennas at RU l and Kₗ denote the number of user-layers served by RU l. The data amount sent from RU l will be Nₗ×Kₗ complex values per physical resource block (PRB) bundle if the channel estimation is performed on one subcarrier per PRB bundle. Aggregation of the channel data from many RUs, as for example in massive D-MIMO, would dramatically increase the traffic load in the aggregated port for sending channel estimation data. On the other hand, If the channel estimation is conducted at the BBU instead, each RU will need to send the received reference signal (if the channel estimation in UL will be used in the DL based on reciprocity) to the BBU via the fronthaul link. The data amount sent from RU l will be Nₗ complex values per resource element (RE) of the scheduled reference signal, e.g., Sounding Reference Signal (SRS). Similar to the previous case, aggregation of reference signals would dramatically increase the traffic load in both the aggregated star-topology and the cascaded topology.

Given the above reasons, recent academic studies have focused on other solutions including partially centralized processing relying on large-scale channel statistics, which is slow channel information and not instantaneous channel information, which as such has flaws, or fully distributed processing, i.e. interference mitigation done locally in each RU. By doing so, exchanging of instantaneous channel information between BBU and RUs can be reduced or avoided, but at the cost of reduced spectrum efficiency compared to the fully centralized processing. As shown above, there is a need for an improved solution for handling transmission of fronthaul data related to DL processing (e.g. user-plane data of DL user layer data, control-plane data regarding channel information, beamforming weights etc.) for distributed base station systems, especially for large scale distributed base station systems such as massive D-MIMO. This solution should preferably be or provide one or more of: scalable; good spectrum efficiency; efficient use of FH resources and good interference mitigation.

### SUMMARY

It is an object of the invention to address at least some of the problems and issues outlined above. It is possible to achieve these objects and others by using methods, RUs, aggregation units (AUs) and BBUs as defined in the attached independent claims.

According to one aspect, a method is provided that is performed by a first RU of a distributed base station system. The first RU comprises N₁ antennas. The distributed base station system further comprises a first AU connected to the first RU via a first AU FH link and a second RU connected to the first AU via a second AU FH link. The second RU comprises N₂ antennas. The distributed base station system further comprises a BBU connected to the first AU over a first BBU FH link. The method comprises obtaining a first DL channel estimate Ĥ₁ of a communication channel between the first RU and a first number of UEs, determining first intermediate BFW C₁ to be used for centralized interference mitigation, based on the first DL channel estimate Ĥ₁, and sending, to the first AU, at least a part of the determined first intermediate BFW C₁. The method according to one alternative further comprises receiving, from the first AU, intermediately-beamformed DL data streams of first user layers K₁ of the first number of UEs intermediately beamformed based on first part of BFW W_{BBU} determined based on an inverse calculation of at least a combination C_{com} of the first intermediate BFW C₁ and second intermediate BFW C₂, determined to be used for centralized interference mitigation based on a second DL channel estimate Ĥ₂ of a communication channel between the second RU and a second number of UEs, obtaining second part of BFW based on the first DL channel estimate Ĥ₁, and beamforming the received intermediately-beamformed DL data streams of the first user layers K₁ based on the second part of BFW into beamformed DL data streams for the first user layers K₁. The method according to another alternative further comprises receiving, from the first AU, DL data streams of the first user layers K₁ and receiving first part of BFW W_{BBU,1} for the first user layers K₁ comprising an inverse calculation of at least the combination C_{com} of the first intermediate BFW C₁ and the second intermediate BFW C₂, determining final BFW based on the first part of BFW W_{BBU,1} for the first user layers and based on the first DL channel estimate Ĥ₁, and beamforming the received DL data streams of the first user layers K₁ based on the determined final BFW into beamformed DL data streams for the first user layers K₁. After any of the two alternatives described have been performed, the method comprises transmitting wirelessly the beamformed DL data streams of the first user layers K₁ to the first number of UEs.

According to another aspect, a method is described that is performed by a first AU of a distributed base station system. The distributed base station system further comprises a first RU comprising N₁ antennas. The first RU is connected to the first AU via a first AU FH link. The distributed base station system further comprises a second RU comprising N₂ antennas. The second RU is connected to the first AU via a second AU FH link. The distributed base station system further comprising a BBU connected to the first AU over a first BBU FH link. The method comprises receiving, from the first RU over the first AU FH link, at least a part of first intermediate BFW C₁ determined to be used for centralized interference mitigation based on a first DL channel estimate Ĥ₁ of a communication channel between the first RU and a first number of UEs, and receiving, from the second RU over the second AU FH link, at least a part of second intermediate BFW C₂ determined to be used for centralized interference mitigation based on a second DL channel estimate Ĥ₂ of a communication channel between the second RU and a second number of UEs. The method further comprises combining the at least part of first intermediate BFW C₁ with the at least part of second intermediate BFW C₂ into combined intermediate BFW C_{com}; and sending, to the BBU over the first BBU FH link, the combined intermediate BFW C_{com}. According to a first alternative, the method further comprises receiving, from the BBU, intermediately-beamformed DL data streams of first user layers K₁ of the first number of UEs and of second user layers K₂ of the second number of UEs, the DL data streams being intermediately beamformed based at least on an inverse calculation of the combined intermediate BFW C_{com}, sending at least the intermediately-beamformed DL data streams of the first user layers to the first RU and sending at least the intermediately-beamformed DL data streams of the second user layers to the second RU. According to a second alternative, the method further comprises receiving, from the BBU, the DL data streams of the first and second user layers K₁, K₂, and at least a part of first part of BFW W_{BBU} determined based at least on an inverse calculation of the combined intermediate BFW C_{com}, sending to the first RU, at least the DL data streams of the first user layers K₁ and at least the first part of BFW W_{BBU,1} that are scheduled to the first RU and sending to the second RU, at least the DL data streams of the second user layers K₂ and at least the first part of BFW W_{BBU,2} that are scheduled to the second RU.

According to another aspect, a method is described that is performed by a BBU system of a wireless communication system. The wireless communication system comprises a distributed base station system. The distributed base station system comprises a BBU, a first AU connected to the BBU over a first BBU FH link, a first RU comprising N₁ antennas, the first RU being connected to the first AU via a first AU FH link, and a second RU comprising N₂ antennas, the second RU being connected to the first AU via a second AU FH link. The method comprises receiving, from the first AU, combined intermediate BFW C_{com} comprising at least part of first intermediate BFW C₁ combined with at least part of second intermediate BFW C₂, the at least part of first intermediate BFW C₁ originating from the first RU and being determined to be used for centralized interference mitigation based on a first DL channel estimate Ĥ₁ of a communication channel between the first RU and a first number of UEs, the at least part of second intermediate BFW C₂ originating from the second RU and being determined to be used for centralized interference mitigation based on a second DL channel estimate Ĥ₂ of a communication channel between the second RU and a second number of UEs. The method further comprises sending, to the first AU, scheduling information comprising information on first user layers K₁ of the first number of UEs to be transmitted in a TTI by the first RU and information on second user layers K₂ of the second number of UEs to be transmitted in the TTI by the second RU, and determining first part of BFW W_{BBU} based on an inverse calculation of at least the received combined intermediate BFW C_{com}. According to a first alternative, the method further comprises performing an intermediate beamforming on DL data streams of the first and second user layers K₁ K₂, based on the first part of BFW W_{BBU}, and sending the intermediately-beamformed DL data streams of the first and second user layers K₁ K₂ to the first AU. According to another alternative, the method further comprises sending, to the first AU, at least a part of the determined first part of BFW W_{BBU} and the DL data streams of the first and second user layers K₁ K₂.

According to another aspect, a first RU is provided that is configured to operate in a distributed base station system. The first RU comprises N₁ antennas. The distributed base station system further comprises a first AU connected to the first RU via a first AU FH link and a second RU connected to the first AU via a second AU FH link. The second RU comprises N₂ antennas. The distributed base station system further comprises a BBU connected to the first AU over a first BBU FH link. The first RU comprises a processing circuitry and a memory. Said memory contains instructions executable by said processing circuitry, whereby the first RU is operative for obtaining a first downlink, DL, channel estimate Ĥ₁ of a communication channel between the first RU and a first number of UEs, determining first intermediate beamforming weights, BFW, C₁ to be used for centralized interference mitigation, based on the first DL channel estimate Ĥ₁ and sending, to the first AU, at least a part of the determined first intermediate BFW C₁. According to a first alternative, the first RU is further operative for receiving, from the first AU, intermediately-beamformed DL data streams of first user layers K₁ of the first number of UEs intermediately beamformed based on first part of BFW W_{BBU} determined based on an inverse calculation of at least a combination C_{com} of the first intermediate BFW C₁ and second intermediate BFW C₂, determined to be used for centralized interference mitigation based on a second DL channel estimate Ĥ₂ of a communication channel between the second RU and a second number of UEs, obtaining second part of BFW based on the first DL channel estimate Ĥ₁, and beamforming the received intermediately-beamformed DL data streams of the first user layers K₁ based on the second part of BFW into beamformed DL data streams for the first user layers K₁. According to a second alternative, the first RU is further operative for receiving, from the first AU, DL data streams of the first user layers K₁ and receiving first part of BFW W_{BBU,1} for the first user layers K₁ comprising an inverse calculation of at least the combination C_{com} Of the first intermediate BFW C₁ and the second intermediate BFW C₂, and determining final BFW based on the first part of BFW W_{BBU,1} for the first user layers and based on the first DL channel estimate, and beamforming the received DL data streams of the first user layers K₁ based on the determined final BFW into beamformed DL data streams for the first user layers K₁. After either the first or the second alternative, the first RU is operative for transmitting the beamformed DL data streams of the first user layers K₁ to the first number of UEs.

According to another aspect, a first AU is provided that is configured to operate in a distributed base station system. The distributed base station system further comprises a first RU comprising N₁ antennas, the first RU being connected to the first AU via a first AU FH link, and a second RU comprising N₂ antennas, the second RU being connected to the first AU via a second AU FH link. The distributed base station system further comprises a BBU connected to the first AU over a first BBU FH link. The first AU comprises a processing circuitry and a memory. Said memory contains instructions executable by said processing circuitry, whereby the first AU is operative for receiving, from the first RU over the first AU FH link, at least a part of first intermediate BFW C₁ determined to be used for centralized interference mitigation based on a first DL channel estimate Ĥ₁ of a communication channel between the first RU and a first number of UEs, and receiving, from the second RU over the second AU FH link, at least a part of second intermediate BFW C₂ determined to be used for centralized interference mitigation based on a second DL channel estimate Ĥ₂ of a communication channel between the second RU and a second number of UEs. The first AU is further operative for combining the at least part of first intermediate BFW C₁ with the at least part of second intermediate BFW C₂ into combined intermediate BFW C_{com}, and sending, to the BBU over the first BBU FH link, the combined intermediate BFW C_{com}. According to a first alternative, the first AU is operative for receiving, from the BBU, intermediately-beamformed DL data streams of first user layers K₁ of the first number of UEs and of second user layers K₂ of the second number of UEs, the DL data streams being intermediately beamformed based on an inverse calculation of at least the combined intermediate BFW C_{com}, sending at least the intermediately-beamformed DL data streams of the first user layers to the first RU and sending at least the intermediately-beamformed DL data streams of the second user layers to the second RU. According to a second alternative, the first AU is operative for receiving, from the BBU, the DL data streams of the first and second user layers K₁, K₂, and at least a part of first part of BFW W_{BBU} determined based on an inverse calculation of at least the combined intermediate BFW C_{com}, sending to the first RU, at least the DL data streams of the first user layers K₁ and at least the first part of BFW W_{BBU,1} that are scheduled to the first RU and sending to the second RU, at least the DL data streams of the second user layers K₂ and at least the first part of BFW W_{BBU,2} that are scheduled to the second RU.

According to another aspect, a BBU system is provided that is configured to operate in a wireless communication system. The wireless communication system comprises a distributed base station system. The distributed base station system comprises a BBU, a first AU connected to the BBU over a first BBU FH link, a first RU comprising N₁ antennas, the first RU being connected to the first AU via a first FH link, and a second RU comprising N₂ antennas, the second RU being connected to the first AU via a second FH link. The BBU system comprises a processing circuitry and a memory. Said memory contains instructions executable by said processing circuitry, whereby the BBU system is operative for receiving, from the first AU, combined intermediate BFW C_{com} comprising at least part of first intermediate BFW C₁ combined with at least part of second intermediate BFW C₂, the at least part of first intermediate BFW C₁ originating from the first RU and being determined to be used for centralized interference mitigation based on a first DL channel estimate Ĥ₁ of a communication channel between the first RU and a first number of UEs, the at least part of second intermediate BFW C₂ originating from the second RU and being determined to be used for centralized interference mitigation based on a second DL channel estimate Ĥ₂ of a communication channel between the second RU and a second number of UEs. The BBU system is further operative for sending, to the first AU, scheduling information comprising information on first user layers K₁ of the first number of UEs to be transmitted in a time transmission interval, TTI, by the first RU and information on second user layers K₂ of the second number of UEs to be transmitted in the TTI by the second RU and determining first part of BFW W_{BBU} based on an inverse calculation of at least the received combined intermediate BFW C_{com}. According to a first alternative, the BBU system is further operative for performing an intermediate beamforming on DL data streams of the first and second user layers K₁ K₂, based on the first part of BFW W_{BBU}, and sending the intermediately-beamformed DL data streams of the first and second user layers K₁ K₂ to the first AU. According to a second alternative, the BBU system is further operative for sending, to the first AU, at least a part of the determined first part of BFW W_{BBU} and the DL data streams of the first and second user layers K₁ K₂.

According to other aspects, computer programs and carriers are also provided, the details of which will be described in the claims and the detailed description.

Further possible features and benefits of this solution will become apparent from the detailed description below.

### BRIEF DESCRIPTION OF DRAWINGS

The solution will now be described in more detail by means of exemplary embodiments and with reference to the accompanying drawings, in which:

FIG. 1 is a schematic block diagram of a wireless communication network having a distributed base station with an architecture according to prior art.

FIG. 2 is a schematic block diagram of a wireless communication network having a distributed base station with another architecture according to prior art.

FIG. 3 is a schematic block diagram of a wireless communication network having a distributed base station with an architecture according to embodiments of the present invention.

FIG. 4 is a flow chart illustrating a method performed by a radio unit (RU), according to possible embodiments.

FIG. 5 is a flow chart illustrating a method performed by an aggregation unit (AU), according to possible embodiments.

FIG. 6 is a flow chart illustrating a method performed by a baseband unit (BBU), according to possible embodiments.

FIG. 7 is a block diagram in more detail of a distributed base station according to an embodiment of the present invention.

FIG. 8 is a block diagram in more detail of a distributed base station according to another embodiment of the present invention.

FIG. 9 is a schematic block diagram of a wireless communication network having a distributed base station with an architecture according to another embodiment of the present invention.

FIG. 10 is a block diagram illustrating a first RU in more detail, according to further possible embodiments.

FIG. 11 is a block diagram illustrating a first AU in more detail, according to further possible embodiments.

FIG. 12 is a block diagram illustrating a BBU system in more detail, according to further possible embodiments.

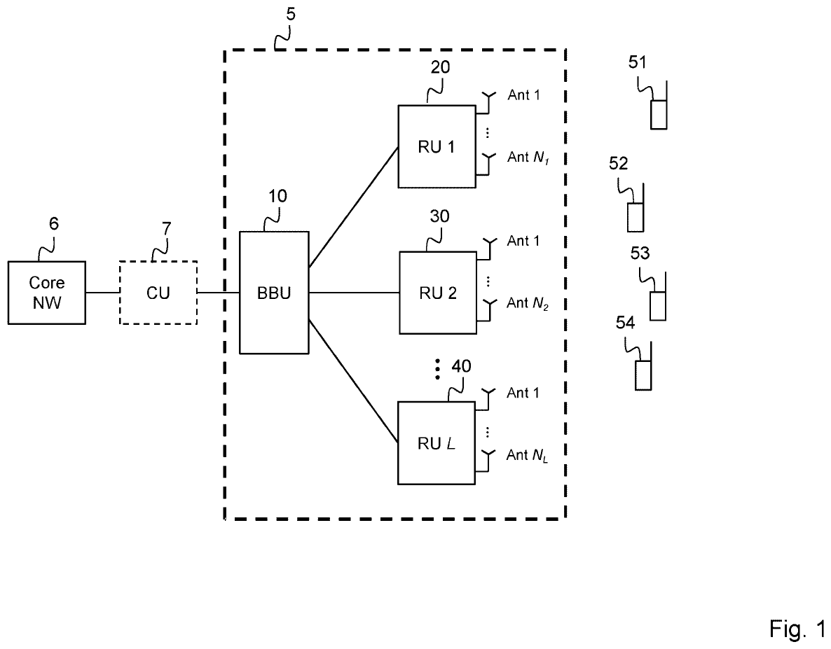

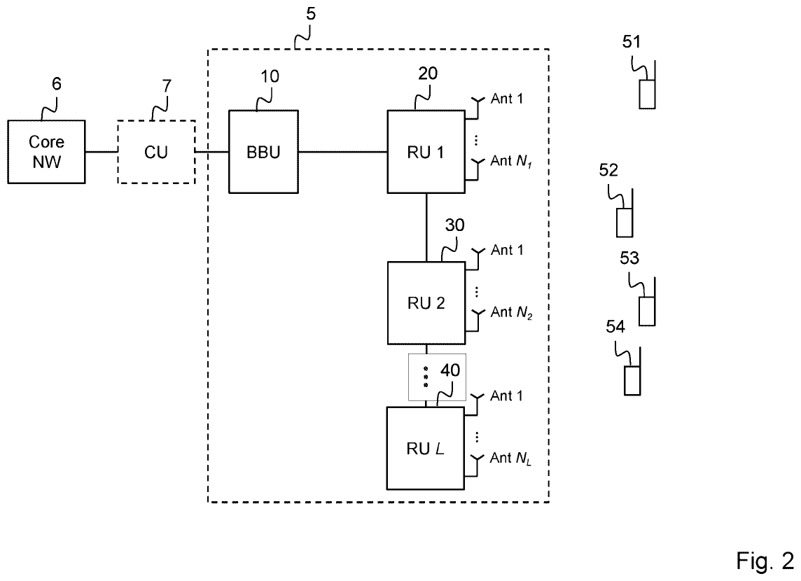

### DETAILED DESCRIPTION

In the following, definitions of the relevant terminologies used in this document are provided.

An “RU” when used herein is a network node comprising radio functions including at least a portion of PHY functions, according to e.g., a Lower Layer Split (LLS) option. The RU performs conversion between radio frequency (RF) signals and baseband signals. At the network end, it transmits and receives the frequency-domain IQ data (modulated user data) or unmodulated user data towards and from the BBU through a fronthaul interface (e.g. eCPRI). At the other end, it transmits and receives RF signals to and from UEs through its antennas. A “BBU” when used herein is a network node performing e.g., baseband processing. It further connects to the core network over a backhaul interface. Note that the BBU and the RU are referred to as O-DU and O-RU, respectively, in O-RAN. O-RAN is described in “Control, User and Synchronization Plane Specification”, O-RAN.WG4.CUS.0-V07.00, as well as its earlier versions. In some terminologies, the RU can be also referred to as a remote radio unit (RRU), and the BBU can also be referred to as a digital unit or distributed unit (DU). In eCPRI terminologies, the BBU and the RU are referred to as eCPRI Radio Equipment Control (eREC) and eCPRI Radio Equipment (eRE), respectively. In another terminology, the BBU and the RU may be referred to as LLS-CU and LLS-DU, respectively. The BBU and its equivalence can also be softwarized or virtualized as a Baseband Processing Function in a Cloud environment. In the following, the general terms of BBU and RU are used to cover a general case.

A “beam” signifies e.g., a directional beam formed by multiplying a signal with different weights, in frequency-domain, at multiple antennas such that the energy of the signal is concentrated towards a certain direction. “Beamforming” signifies e.g., a technique which multiplies a signal with different weights in frequency-domain at multiple antennas, which enables the signal energy to be sent in space with a desired beam pattern by forming a directional beam concentrating towards certain direction(s) or forming nulling in certain direction(s), or a combination of both. “Beamforming weights (BFW)” signifies e.g., sets of complex weights, each set being multiplied with a signal of one user-layer at a subcarrier or a group of subcarriers. The weighted signals of different user layers towards the same antenna or transmit beam are combined linearly. As a result, different user-layer signals are beamformed to different directions. The BFW are in frequency domain. A “user-layer” signifies e.g., an independent downlink or uplink data stream intended for one UE. Note that one UE may have one or multiple user-layers. A “desired cell/channel” may signify the cell/channel which connects to the UEs of K user-layers. “User-plane data” signifies e.g., frequency-domain user-layer data sent over the fronthaul. The wording “beamforming performance” may signify signal quality in downlink (DL) at the UE side after the beamforming has been performed at the base-station side, measured by, for example, post-processing signal-to-interference-and-noise-power ratio (SINR) at the UE, resulted user throughput, bit rate, etc. The wording “channel information” signifies e.g., information about channel properties carried by channel values. The wording “channel value”, also referred to as channel data, signifies e.g., one or a set of complex values representing amplitude and phase of the channel coefficients in frequency domain. The channel values are related to the frequency response of the wireless channel.

“Aggregation unit (AU)” when used herein signifies e.g., a node that aggregates fronthaul traffic from multiple RU ports to one BBU port. On the RU side, each RU port connects to one port of the aggregation unit via a physical medium, e.g. electrical cable or fiber, or via a network, e.g. an Ethernet or IP network. The traffic from all connected RU ports is aggregated to another port called aggregation port. The aggregation port is connected to one BBU port via a physical medium, e.g. electrical cable or fiber.

Embodiments of the present invention are built upon a design of an aggregation unit (AU), which would be a node of a distributed base station system that is inserted in between the BBU and the multiple RUs. In uplink, the AU aggregates FH traffic between multiple RU ports and the BBU. In downlink, the AU distributes aka fans-out the traffic from the BBU towards the multiple RUs. Thanks to inserting one or more AUs in between the BBU and the RUs, the distributed base station system will have a high scalability. In other words, it will be easy to insert extra RUs into the system, connecting them to one of the AUs. Furthermore, as the required FH load does not scale with the number of connected RUs/antennas, the amount of FH data will at least not increase as much on the aggregation port as for prior art, when adding extra RUs. Eventually, it is not needed to increase the link speed of the aggregation port connected to the BBU in the same amount as for prior art. For example, assume that there are 4 RUs and each RU has 4 antennas, where 4 UEs are connected to all 4 RUs and each UE has one user-layer data traffic. With this invention, the BBU only needs to send 4 DL data streams in user-plane (i.e. equal to the number of layers) where each RU receives the 4 data streams and performs a RU-specific beamforming on these data streams, while DU in prior art needs to send 16 data streams (i.e., the total number of antennas) where each group of 4 data streams are dedicated to each RU. According to an embodiment, channel estimation is conducted locally at the respective RUs and stored in a channel state memory at the respective RUs. Each RU also calculates intermediate BFW, i.e. a covariance matrix of the local channel matrix of each RU, the dimension of which scales only with the number of user layers served by that RU. Each RU then sends the intermediate BFW to the connected AU. Each AU combines the received intermediate BFW and sends the combined intermediate BFW to the BBU. In one embodiment, there may be cascade-coupled AUs. In this case, each intermediate AU in the cascade chain also combines its own combined intermediate BFW with the combined intermediate BFW received from the previous AU in the chain, and forwards updated combined intermediate BFW to the next AU. The BBU sends scheduling information including user-layer identification to each AU to assist proper combination of the intermediate BFW at each AU. If the BBU receives more than one set of combined intermediate BFW from more than one AU, it also combines the received combined intermediate BFW and calculates a first part of BFW for centralized interference mitigation based on the finally combined intermediate BFW. In one embodiment, the BBU conducts first part of beamforming of DL user layer signals based on the first part of BFW and each RU then conducts second part of beamforming of the DL user layers that were first part-beamformed based on the local channel estimates saved in its channel state memory. In another embodiment, the BBU sends the calculated first part of BFW to each AU which then sends it further to each connected RU. Each RU then conducts beamforming on DL user layer signals based both on the received first part of BFW and on the local channel estimates saved in its channel state memory. Note that the aggregation unit together with its connected physical RUs can be seen as a bigger virtual RU with the number of antennas of all physical RUs connected, from the BBU perspective.

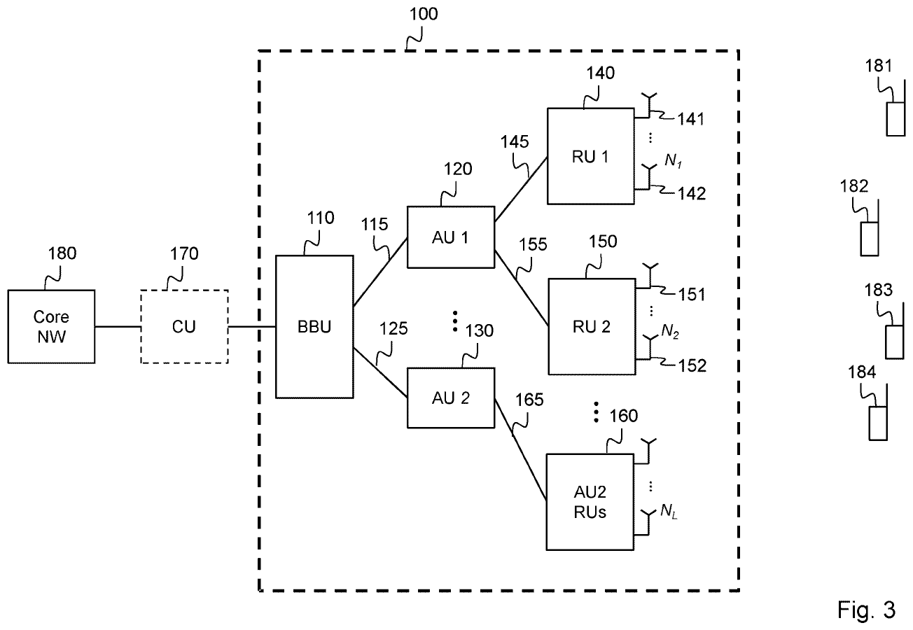

FIG. 3 illustrates a wireless communication network comprising a distributed base station system 100 according to embodiments of the invention. The distributed base station system 100 comprises a BBU 110, a first AU 120 connected to the BBU 110 via a first BBU FH link 115, a first RU 140 connected to the first AU 120 via a first AU FH link 145 and a second RU 150 connected to the first AU 120 via a second AU FH link 155. The first RU 140 comprises a plurality of (N₁) antennas 141, 142. The second RU 150 comprises a plurality of (N₂) antennas 151, 152. There may be many more RUs connected to the first AU 120 than the first and the second RU 140, 150. Two RUs are only shown for simplicity and easier understanding. The distributed base station system 100 may further comprise a second AU 130 connected to the BBU 110 via a second BBU FH link 125, and one or more second AU RUs 160 connected to the second AU via one or more additional AU FH link 165. In FIG. 3, the one or more second AU RUs 160 and their respective additional AU FH link are illustrated by only one RU 160 and AU FH link 165 for drawing simplicity only. A skilled person would understand that this AU RU and its corresponding AU FH link can be interpreted as more than one. Further, there may be more than two AUs, and each AU may have more than two RUs connected to it. The BBU 110 has connections to other base station nodes or other RAN nodes and further to a core network 180 over a backhaul link possibly via a CU 170 so that the distributed base station system 100 can communicate with other nodes of the communication network. The FH links 115, 125, 145, 155, 165 may each be any kind of connection, such as a dedicated wireline or wireless connection or a connection via a network, as long as the connection fulfils fronthaul requirements, e.g. in capacity and latency. The first RUs 140, 150, 160 communicate wireless signals towards and from one or more UEs 181, 182, 183, 184 via their respective antennas. The wireless signals comprise data to be communicated from or to the UEs 181, 182, 183, 184.

The wireless communication network may be any kind of wireless communication network that can provide radio access to wireless devices. Example of such wireless communication networks are networks based on Long Term Evolution (LTE), LTE Advanced, Wireless Local Area Networks (WLAN), Worldwide Interoperability for Microwave Access (WiMAX), WiMAX Advanced, as well as fifth generation (5G) wireless communication networks based on technology such as New Radio (NR), and any possible future sixth generation (6G) wireless communication network.

The UEs 181, 182, 183, 184 may be any type of communication device capable of wirelessly communicating with the RUs 140, 150, 160 using radio signals. For example, the UEs may be a machine type UE or a UE capable of machine to machine (M2M) communication, a sensor, a tablet, a mobile terminal, a smart phone, a laptop embedded equipped (LEE), a laptop mounted equipment (LME), a USB dongle, a Customer Premises Equipment (CPE) etc.

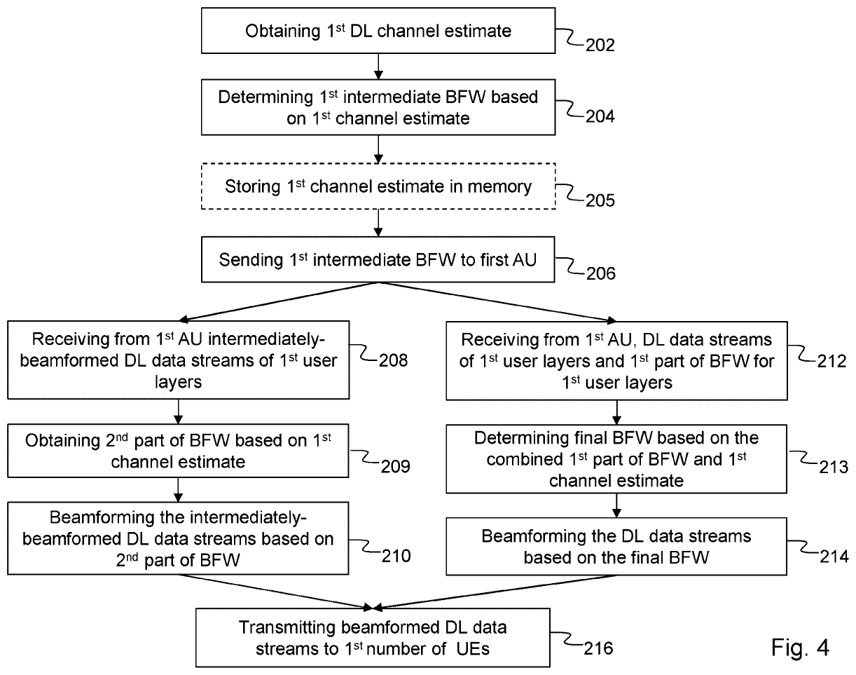

FIG. 4, in conjunction with FIG. 3, describes a method performed by a first RU 140 of a distributed base station system 100. The first RU 140 comprises N₁ antennas 141, 142. The distributed base station system 100 further comprises a first AU 120 connected to the first RU 140 via a first AU FH link 145 and a second RU 150 connected to the first AU 120 via a second AU FH link 155. The second RU 150 comprises N₂ antennas 151, 152. The distributed base station system 100 further comprises a BBU 110 connected to the first AU 120 over a first BBU FH link 115. The method comprises obtaining 202 a first DL channel estimate Ĥ₁ of a communication channel between the first RU 140 and a first number of UEs 181, 182, 183, determining 204 first intermediate BFW C₁ to be used for centralized interference mitigation, based on the first DL channel estimate Ĥ₁, and sending 206, to the first AU 120, at least a part of the determined first intermediate BFW C₁. The method according to one alternative further comprises receiving 208, from the first AU 120, intermediately-beamformed DL data streams of first user layers K₁ of the first number of UEs 181, 182, 183 intermediately beamformed based on first part of BFW W_{BBU} determined based on an inverse calculation of at least a combination C_{com} of the first intermediate BFW C₁ and second intermediate BFW C₂, determined to be used for centralized interference mitigation based on a second DL channel estimate Ĥ₂ of a communication channel between the second RU 150 and a second number of UEs 182, 183, 184, obtaining 209 second part of BFW based on the first DL channel estimate Ĥ₁, and beamforming 210 the received intermediately-beamformed DL data streams of the first user layers K₁ based on the second part of BFW into beamformed DL data streams for the first user layers K₁. The method according to another alternative further comprises receiving 212, from the first AU 120, DL data streams of the first user layers K₁ and receiving first part of BFW W_{BBU,1} for the first user layers K₁ comprising an inverse calculation of at least the combination C_{com} of the first intermediate BFW C₁ and the second intermediate BFW C₂, determining 213 final BFW based on the first part of BFW W_{BBU,1} for the first user layers and based on the first DL channel estimate Ĥ₁, and beamforming 214 the received DL data streams of the first user layers K₁ based on the determined final BFW into beamformed DL data streams for the first user layers K₁. After any of the two alternatives described have been performed, the method comprises transmitting wirelessly 216 the beamformed DL data streams of the first user layers K₁ to the first number of UEs 181, 182, 183.

The use of at least one AU instead of having direct connections from the RUs to the BBU means that the amount and length of cables from the plurality of RUs to the BBU will be decreased, especially if there is a larger distance from the RUs to the BBU and the at least one AU is positioned close to the RUs. Further, the scalability is higher by using AUs. An additional AU can easily be added in the base station system. If the number of RUs increases and there is no AU in between there has to be the same number of ports at the BBU as number of RUs, which means there will be difficulties with scalability, i.e. adding many extra RUs in the system. An AU FH link is between an AU and an RU. A BBU FH link is between a BBU and an AU. The DL channel estimate is normally obtained by the respective RU from measurements on UL signals from the respective number of UEs and presumed reciprocity of UL and DL. Alternatively, it could be obtained from measurements performed by the first number of UEs on DL signals sent towards the first number of UEs. The measurements are then sent to the first RU by the first number of UEs. For obtaining the first DL channel estimate, the first RU may need to know some scheduling information, such as information regarding reference signals sent by the first UEs and IDs of the first UEs sending the reference signals. The information on reference signals may be reference signal configuration and sequence and information on communication resources, i.e. time-frequency resources on which the reference signals are sent. Some of this scheduling information may be statically configured. The same is applicable for the second RU for obtaining the second DL channel estimate as well as for any other RUs in the system.

The method describes two alternative ways, which is also clear from the flow chart of FIG. 4. Either the steps receiving 208, obtaining 209 and beamforming 210 are performed, or the steps receiving 212, determining 213 and beamforming 214. The received 208 intermediately-beamformed DL data streams of the first user layers K₁ are intermediately beamformed by the BBU. The received 212 first part of BFW W_{BBU,1} for the first user layers K₁ are inversely calculated by the BBU. That at least a part of the first intermediate BFW are sent 206 to the first AU may signify that either all first intermediate BFW are sent or only a subset of the intermediate BFW is sent, such as only upper or lower triangular components of a matrix of the first intermediate BFW. The first number of UEs 181, 182, 183 are defined as being connected to the first RU 140 and the second number of UEs 182, 183, 184 are defined as being connected to the second RU 150. There may or may not be an overlap of the first and second number of UEs. In fact, the method is more beneficial when there is an overlap. In a special case, the first and the second UEs are the same UEs. This is also one assumption and purpose for the deployment for such a distributed base station system, i.e., the RUs are densely deployed to further increase spectrum efficiency and cell capacity. In such dense deployment, UEs are connected simultaneously to multiple RUs.

In the distributed base station system, there may be many such parallel RUs connected to the same AU, i.e. not just the first and second RU mentioned above. Also, there may be more than one parallel AU, and even cascade-coupled RUs. C_{com} is then a combination of intermediate BFW from all those RUs.

The above-described method provides improved performance of centralized beamforming in distributed base station systems such as massive D-MIMO system without suffering from any possible exploding of FH load at the aggregation unit as well as between the aggregation unit and the BBU associated as the number of RUs being connected to the BBU increases. The required fronthaul load for user-plane data and control-plane data relating to BFW will only be scaled with the total number of served user-layers, i.e., it is independent of the number of connected RUs, the number of scheduled user layers at each RU, and the number of antennas equipped at each RU.

According to an embodiment, the second part of BFW are obtained 209 as a as a Hermitian transpose Ĥ₁^{H} of the first DL channel estimate Ĥ₁, and/or the final BFW are determined 213 based on the first part of BFW W_{BBU,1} for the first user layers and based on the Hermitian transpose Ĥ₁^{H} of the first DL channel estimate.

According to an embodiment, the method further comprises storing 205 information on the first DL channel estimate Ĥ₁. The information on the first DL channel estimate is stored in an internal memory of the first RU, such as in a channel state memory. By storing information on the first DL channel estimate in a memory of the first RU after the first DL channel estimate has been determined 204, the first DL channel estimate does not have to be calculated again when it is to be used in either the obtaining step 209 or the determining step 213. The information on the first DL channel estimate may comprise terms of the first DL channel estimate and/or of the Hermitian transpose of the first DL channel estimate.

According to another embodiment, the at least part of first intermediate BFW C₁ that are sent 206 to the first AU comprises only a subset of the first intermediate BFW C₁ that can be used by the first AU for recovering full first intermediate BFW. The subset of the first intermediate BFW may comprise only upper or lower triangular components of a matrix of the first intermediate BFW or a combination of the upper and lower triangular components. Hereby, the number of intermediate BFW that need to be transported to the AU is reduced, which means that capacity on the first AU FH is saved. When only upper or lower triangular components are sent, the number of intermediate BFW is reduced from K1*K1 to (K1*K1+K1)/2. As is proved further down in this document, only transporting the upper or lower triangular components of the first intermediate BFW, or a combination thereof, may be enough to convey the information of the first intermediate BFW.

According to another embodiment, the method further comprises obtaining, from neighboring cells, information on interference experienced at the neighboring cells from DL signals sent by the first RU, and wherein the first intermediate BFW C₁ are determined 204 also based on the obtained information on interference. “Neighboring cells” in this context signify cells outside the base station system, that is cells handled by base stations different from this base station system.

According to another embodiment, the first intermediate BFW C₁ are determined 204 based on Ĥ₁^{H}Ĥ₁, where Ĥ₁^{H} is a Hermitian transpose of the first DL channel estimate Ĥ₁. In such an embodiment, the second intermediate BFW C₂ may be determined by the second RU based on Ĥ₂^{H}Ĥ₂, where Ĥ₁^{H} is a Hermitian transpose of the second DL channel estimate Ĥ₂. As an alternative, when interference is considered, the first intermediate BFW C₁ may be determined based on Ĥ₁Ĥ₁^{H} plus the covariance of interferences.

According to yet another embodiment, the method further comprises receiving, from the first AU, scheduling information comprising information on the first user layers K₁ to be transmitted in a time transmission interval (TTI) by the first RU 140. Further, the receiving 208, from the first AU 120, of intermediately-beamformed DL data streams comprises receiving intermediately-beamformed data streams of the first and the second user layers K₁, K₂, and the method further comprises selecting, for the beamforming 210, only the intermediately-beamformed DL data streams of the first user layers K₁ from the received intermediately-beamformed DL data streams of the first and second user layers K₁, K₂ based on the received scheduling information. The first RU may receive intermediately-beamformed DL data streams of only the first user layers that are to be transmitted from the first RU or it may receive both the first and second user layers that are to be transmitted from both the first and the second RU, that is for all user layers of the first AU. In case intermediately beamformed data streams for all layers are received at the first RU, the first RU makes a selection of only the intermediately-beamformed DL data streams for the first user layers, based on the scheduling information. A benefit with this alternative is that the first AU can be designed simpler since it does not need to interpret the scheduling information, compared to if the AU makes the same selection. On the other hand, when the selection is performed at the AU instead of at the RU, each RU can be made simpler, and also a bit of traffic is saved over the respective AU FH link.

According to another embodiment, the method further comprises receiving, from the first AU, scheduling information comprising information on the first user layers K₁ to be transmitted in a TTI by the first RU 140. Further, the receiving 212, from the first AU 120, of the DL data streams of the first user layers K₁ and the first part of BFW W_{BBU,1} that are scheduled to the first RU comprises receiving the DL data streams of the first and second user layers K₁, K₂ and the first part of BFW W_{BBU} that are scheduled to the first and the second RU, the method further comprising selecting, for the determining 213 and the beamforming 214, only the DL data streams of the first user layers K₁ and the first part of BFW W_{BBU,1} that are scheduled to the first RU based on the received scheduling information. In case the first part of BFW for both first and second user layers, that is all first part of BFW received from the first AU, as well as the DL data streams for both first and second user layers, that is all user layers of the first AU, are received at the RU, the first RU makes a selection of only the first part of BFW for the first user layers as well as the DL data streams of the first user layers, based on scheduling information. A benefit with this alternative is that the first AU can be designed simpler since it does not need to interpret the scheduling information.

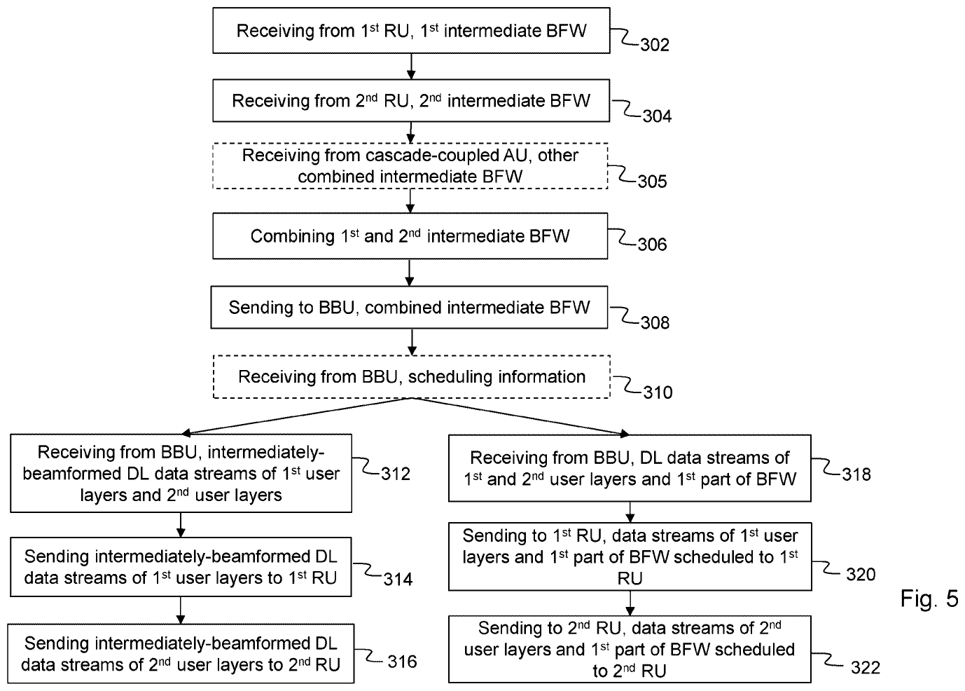

FIG. 5, in conjunction with FIG. 3, describes a method performed by a first aggregation unit, AU, 120 of a distributed base station system 100. The distributed base station system 100 further comprises a first RU 140 comprising N₁ antennas 141, 142. The first RU 140 is connected to the first AU 120 via a first AU FH link 145. The distributed base station system 100 further comprises a second RU 150 comprising N₂ antennas 151, 152. The second RU 150 is connected to the first AU 120 via a second AU FH link 155. The distributed base station system 100 further comprising a BBU 110 connected to the first AU 120 over a first BBU FH link 115. The method comprises receiving 302, from the first RU 140 over the first AU FH link 145, at least a part of first intermediate BFW C₁ determined to be used for centralized interference mitigation based on a first DL channel estimate Ĥ₁ of a communication channel between the first RU 140 and a first number of UEs 181, 182, 183, and receiving 304, from the second RU 150 over the second AU FH link 155, at least a part of second intermediate BFW C₂ determined to be used for centralized interference mitigation based on a second DL channel estimate Ĥ₂ of a communication channel between the second RU 150 and a second number of UEs 182, 183, 184. The method further comprises combining 306 the at least part of first intermediate BFW C₁ with the at least part of second intermediate BFW C₂ into combined intermediate BFW C_{com}; and sending 308, to the BBU 110 over the first BBU FH link 115, the combined intermediate BFW C_{com}. According to a first alternative, the method further comprises receiving 312, from the BBU 110, intermediately-beamformed DL data streams of first user layers K₁ of the first number of UEs 181, 182, 183 and of second user layers K₂ of the second number of UEs 182, 183, 184, the DL data streams being intermediately beamformed based on an inverse calculation of at least the combined intermediate BFW C_{com}, sending 314 at least the intermediately-beamformed DL data streams of the first user layers to the first RU 140 and sending 316 at least the intermediately-beamformed DL data streams of the second user layers to the second RU 150. According to a second alternative, the method further comprises receiving 318, from the BBU 110, the DL data streams of the first and second user layers K₁, K₂, and at least a part of first part of BFW W_{BBU} determined based on an inverse calculation of at least the combined intermediate BFW C_{com}, sending 320 to the first RU 140, at least the DL data streams of the first user layers K₁ and at least the first part of BFW W_{BBU,1} that are scheduled to the first RU and sending 322 to the second RU 150, at least the DL data streams of the second user layers K₂ and at least the first part of BFW W_{BBU,2} that are scheduled to the second RU.

The first intermediate BFW C₁ are determined by the first RU. The second intermediate BFW C₂ are determined by the second RU. Either all first intermediate BFW are received 302 from the first RU or only a subset of the first intermediate BFW are received from the first RU. Similarly, either all second intermediate BFW are received 304 from the second RU or only a subset of the second intermediate BFW are received from the second RU.

There may be an overlap of the first and second user layers, i.e. at least some of the first user layers and the second user layers may be the same. It may even be so that the first user layers and the second user layers are the same layers. The intermediately beamformed DL data streams of first and second user layers are normally received 312 together and when there is an overlap of some of the first and second user layers they are only received once. In case the first and the second user layers are the same, the scheduling information comprising information on the first user layers K₁ to be transmitted in a TTI by the first RU 140 and on the second user layers K₂ to be transmitted in the TTI by the second RU 150 discussed below may not be necessary.

The sending 314 of at least the intermediately-beamformed DL data streams of the first user layers to the first RU and the sending of at least the intermediately-beamformed DL data streams of the second user layers to the second RU may according to a first embodiment signify that the first AU just sends all intermediately-beamformed DL data streams of the first and second user layers to both the first and the second RU, and let the first and second RU, respectively, do the selection of which of the user layers that are to be sent to the first UEs by the first RU and which of the user layers that are to be sent to the second UEs by the second RU. This selection can be made based on scheduling information. Alternatively, the first AU only sends the intermediately-beamformed DL data streams of the first user layers to the first RU and the intermediately-beamformed DL data streams of the second user layers to the second RU. In case the first and second user layers are at least partly different this may comprise extracting the DL data streams of first user layers and the DL data streams of the second user layers out of the total user layers. The extracting may be done based on scheduling information.

The sending 320 to the first RU of at least the DL data streams of the first user layers K₁ and at least the first part of BFW W_{BBU,1} that are scheduled to the first RU may according to a first embodiment signify that the first AU just sends to the first RU all first part of BFW W_{BBU}, i.e. the first part of BFW that are scheduled to the first RU and the first part of BFW that are scheduled to the second RU, and all the DL data streams of the first and second user layers K₁ K₂ to the first RU and let the first RU do the selection of which of the user layers that are to be sent to the first UEs by the first RU. This selection can be made based on scheduling information. Similarly, the sending 322 to the second RU of at least the DL data streams of the second user layers K₂ and at least the first part of BFW W_{BBU,2} that are scheduled to the second RU signifies that the first AU just sends to the second RU all first part of BFW W_{BBU}, i.e. the first part of BFW that are scheduled to the first RU and the first part of BFW that are scheduled to the second RU, and all the DL data streams of the first and second user layers K₁ K₂ and let the second RU do the selection of the first part of BFW W_{BBU,2} that are scheduled to the second RU and the second user layers K₂. This selection can be made based on scheduling information. Alternatively, the first AU only sends 320, to the first RU, the first part of BFW W_{BBU,1} that are scheduled to the first RU and the DL data streams of the first user layers K₁. Similarly, the first AU only sends 322, to the second RU, the first part of BFW W_{BBU,2} that are scheduled to the second RU and the DL data streams of the second user layers K₂. In case the DL data streams of the first and second user layers are at least partly different this may comprise extracting the DL data streams of first user layers and the DL data streams of the second user layers out of all DL data streams of the first and second user layers. The extracting may be done based on scheduling information.

According to an embodiment, the method further comprises receiving 310, from the BBU 110, scheduling information comprising information on the first user layers K₁ to be transmitted in a TTI by the first RU 140 and on the second user layers K₂ to be transmitted in the TTI by the second RU 150, and sending the received 310 scheduling information to the first RU and the second RU. Further, the sending 314 of at least the intermediately-beamformed DL data streams of the first user layers to the first RU and the sending 316 of at least the intermediately-beamformed DL data streams of the second user layers to the second RU comprises sending all intermediately-beamformed DL data streams of the first and the second user layers to both the first and the second RU. In this case, the first and the second RU, respectively, makes the selection of the first and second intermediately-beamformed DL data streams based on the scheduling information that originates from the BBU. This has the advantage that the first AU can be made simpler than in the second embodiment where scheduling information is taken into consideration by the first AU. However, more data needs to be sent over the AU FH link towards the respective RU compared to the second embodiment.

According to another embodiment, the method further comprises receiving 310, from the BBU 110, scheduling information comprising information on the first user layers K₁ to be transmitted in a time transmission interval (TTI) by the first RU 140 and on the second user layers K₂ to be transmitted in the TTI by the second RU 150, and extracting the intermediately-beamformed DL data streams of the first user layers K₁ and the intermediately-beamformed DL data streams of the second user layers K₂. Further, the sending 314 of at least the intermediately-beamformed DL data streams of the first user layers to the first RU comprises sending only the extracted intermediately-beamformed DL data streams of the first user layers K₁ to the first RU, and the sending 316 of at least the intermediately-beamformed DL data streams of the second user layers to the second RU comprises sending only the extracted intermediately-beamformed DL data streams of the second user layers K₂ to the second RU.

In this case, the AU makes the selection of intermediately-beamformed DL data streams of the first user layers based on the scheduling information and sends them to the first RU, and the selection of intermediately-beamformed DL data streams of the second user layers based on the scheduling information and sends them to the second RU. This has the advantage that the first and second RUs can be made simpler than in the above embodiment where scheduling information is not taken into consideration by the AU. Also, less data needs to be sent over the AU FH link towards the respective RU compared to the above embodiment.

According to another embodiment, the at least part of first intermediate BFW C₁ that are received 302 from the first RU comprises only a subset of the first intermediate BFW C₁, and the at least part of second intermediate BFW C₂ that are received 304 from the second RU comprises only a subset of the second intermediate BFW C₂. Further, the combining 306 of the at least one first intermediate BFW C₁ with the at least one second intermediate BFW C₂ into combined intermediate BFW C_{com} comprises combining the subset of the first intermediate BFW with the subset of the second intermediate BFW and wherein the sending 308 of the combined intermediate BFW C_{com} comprises sending the combination of the subset of the first intermediate BFW with the subset of the second intermediate BFW to the BBU 110.

The subset of the first intermediate BFW may comprise only upper or lower triangular components of a matrix of the first intermediate BFW or a combination of the upper and lower triangular components. Hereby, the number of intermediate BFW that need to be transported to the AU is reduced compared to sending all first or second intermediate BFW, which means that capacity on the first or second AU FH, respectively, is saved. A combination of the whole set of the combined first and second intermediate BFW may be recovered by the BBU based on Hermitian symmetry property of the combined subset.

According to another embodiment, the at least a part of first part of BFW W_{BBU} that are received 318 from the BBU 110 comprises only a subset of the first part of BFW W_{BBU}. The method further comprises recovering the whole first part of BFW from the subset of the first part of BFW W_{BBU} based on Hermitian symmetry property of the first part of BFW W_{BBU}. The subset of the first part of BFW W_{BBU} may comprise only upper or lower triangular components of a matrix of the first part of BFW W_{BBU} or a combination of the upper and lower triangular components.

According to yet another embodiment, the distributed base station system 100 further comprises a cascade-coupled AU 470 connected to the first AU 120 via an AU-AU FH link 480, the cascade-coupled AU 470 being also connected to one or more other RUs 490 from which it receives intermediate BFW determined by respective ones of the one or more other RUs 490. The method further comprises receiving 305, from the cascade-coupled AU 470 over the AU-AU FH link 480, other combined intermediate BFW that the cascade-coupled AU 470 has combined based on the intermediate BFW it has received from its one or more other RUs 490. Further, the combining 306 of intermediate BFW further comprises also combining the received 305 other combined intermediate BFW with the at least part of first and the at least part of second intermediate BFW into the combined intermediate BFW that are sent 308 to the BBU 110.

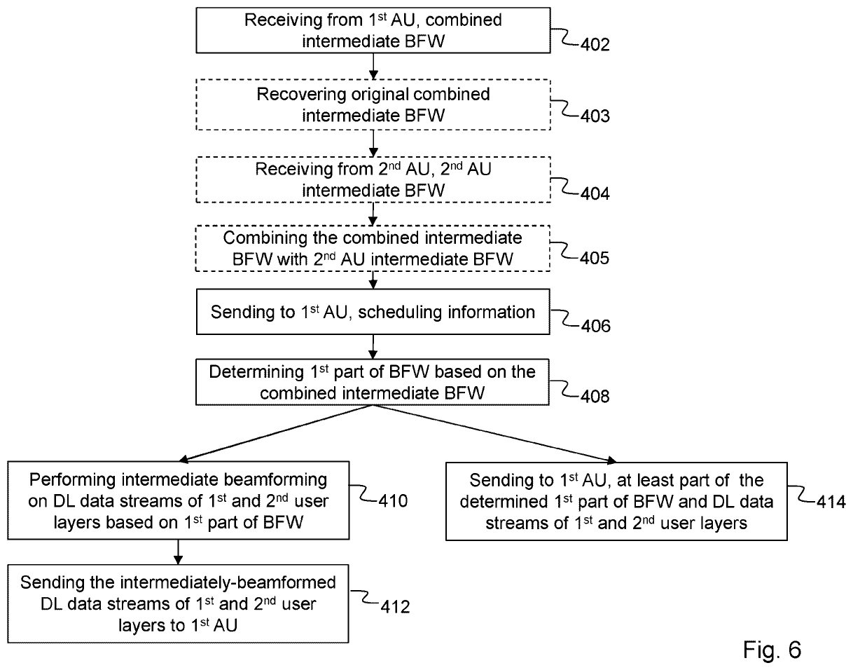

FIG. 6, in conjunction with FIG. 3, describes a method performed by a BBU system 600 of a wireless communication system. The wireless communication system comprises a distributed base station system 100. The distributed base station system 100 comprises a BBU 110, a first aggregation unit, AU, 120 connected to the BBU 110 over a first BBU FH link 115, a first RU 140 comprising N₁ antennas 141, 142, the first RU 140 being connected to the first AU 120 via a first AU FH link 145, and a second RU 150 comprising N₂ antennas 151, 152, the second RU being connected to the first AU 120 via a second AU FH link 155. The method comprises receiving 402, from the first AU 120, combined intermediate BFW C_{com} comprising at least part of first intermediate BFW C₁ combined with at least part of second intermediate BFW C₂, the at least part of first intermediate BFW C₁ originating from the first RU 140 and being determined to be used for centralized interference mitigation based on a first DL channel estimate Ĥ₁ of a communication channel between the first RU 140 and a first number of UEs 181, 182, 183, the at least part of second intermediate BFW C₂ originating from the second RU 150 and being determined to be used for centralized interference mitigation based on a second DL channel estimate Ĥ₂ of a communication channel between the second RU 150 and a second number of UEs 182, 183, 184. The method further comprises sending 406, to the first AU 120, scheduling information comprising information on first user layers K₁ of the first number of UEs 181, 182, 183 to be transmitted in a time transmission interval, TTI, by the first RU 140 and information on second user layers K₂ of the second number of UEs 182, 183, 184 to be transmitted in the TTI by the second RU 150, and determining 408 first part of BFW W_{BBU} based on an inverse calculation of at least the received combined intermediate BFW C_{com}. According to a first alternative, the method further comprises performing 410 an intermediate beamforming on DL data streams of the first and second user layers K₁, K₂, based on the first part of BFW W_{BBU}, and sending 412 the intermediately-beamformed DL data streams of the first and second user layers K₁, K₂ to the first AU 120. According to another alternative, the method further comprises sending 414, to the first AU 120, at least a part of the determined first part of BFW W_{BBU} and the DL data streams of the first and second user layers K₁, K₂.

The BBU system 600 may be arranged at or in the BBU 110. Alternatively, the BBU system 600 may be arranged at or in any other network node of the wireless communication network 100. Alternatively, the BBU system 600 may be realized as one or more network entities or a group of network nodes, wherein functionality of the BBU system 600 is spread out over the one or more network entities group of network nodes. The group of network nodes may be different physical, or virtual, nodes of the network. This latter alternative realization may be called a cloud-solution. As mentioned, there may be an overlap of the DL data streams of the first and second user layers. In other words, some of the DL data streams of the first user layers are the same as the DL data streams of some of the second user layers. In those cases, only one DL data stream is sent or beamformed.

According to an embodiment, the combined intermediate BFW C_{com} are received 402 as only a subset of the combined intermediate BFW. Further, the method comprises recovering 403 the combined intermediate BFW from the subset based on Hermitian symmetry property of the combined intermediate BFW C_{com}. In other words, all combined intermediate BFW are recovered 403 even if only a subset is received

According to an embodiment, the at least a part of the first part of BFW W_{BBU} that are sent 414 to the first AU 120 comprises only a subset of the first part of BFW W_{BBU}. The subset of the first part of BFW W_{BBU} may comprise only upper or lower triangular components of a matrix of the first part of BFW W_{BBU} or a combination of the upper and lower triangular components.

According to an embodiment, the determining 408 of first part of BFW W_{BBU} is also based on interference experienced at neighboring cells, so that the first part of BFW is calculated as the inverse of the combined intermediate BFW added with a factor based on the experienced interference.

According to a variant of this embodiment, the factor is a regularization term δ²I where I is an identity matrix and δ² is a regularization factor that is based on an estimate of power of interference and/or noise. δ²I may be determined from UE report such as channel quality indicator CQI, Reference Signal Received Quality RSRQ, Reference Signal Received Power RSRP etc.

According to another embodiment, the distributed base station system 100 further comprises a second AU 130 connected to the BBU 110 via a second BBU FH link 125, the second AU 130 being also connected to one or more second AU RUs 160. The method further comprises receiving 404, from the second AU 130, second AU intermediate BFW originating from the one or more second AU RUs 160 and being determined to be used for centralized interference mitigation based on DL channel estimates of communication channels between the one or more second AU RUs 160 and a third number of UEs connected to the one or more second AU RUs 160, and combining 405 the combined intermediate BFW received from the first AU 120 with the second AU intermediate BFW received from the second AU 130 into finally combined intermediate BFW. Further, the determining 408 of the first part of BFW W_{BBU} is based on an inverse calculation of at least the finally combined intermediate BFW.

This combining of intermediate BFW from different AUs is useful if there is an overlap of the UEs connected to RUs of the first AU and the UEs connected to RUs of the second AU. In case there are two or more second AU RUs, the second AU intermediate BFW may be determined by the second AU in the same way as the combined intermediate BFW are determined by the first AU.

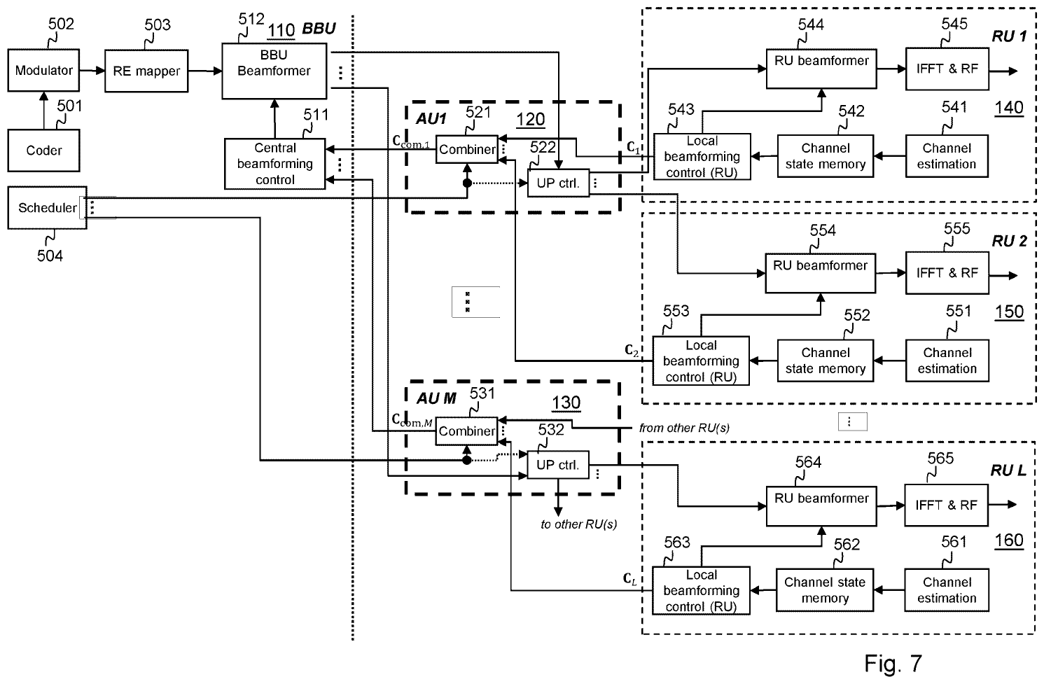

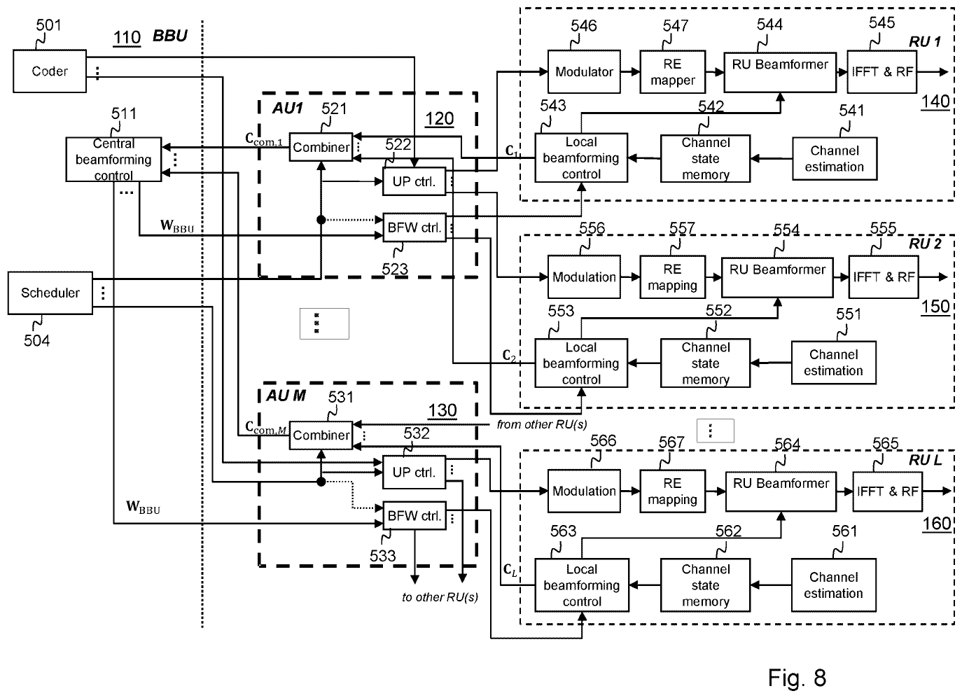

FIG. 7 describes a distributed base station system according to an embodiment that handles DL user layer signals according to a first alternative. FIG. 8 described a distributed base station system according to an embodiment that handles DL user layer signals according to a second alternative. The distributed base station systems of FIGS. 7 and 8 has a basic architecture similar to the system of FIG. 3, that is a BBU, at least one AU, exemplified by two AUs in FIGS. 3, 7, 8 and at least two RUs exemplified by three RUs in FIGS. 3, 7 and 8. In both scenarios, i.e. the first and second alternative, a total number of K user layer, aka user layer signals are served by a BBU 110. The BBU 110 is connected to L RUs 140, 150, 160 via M aggregation units 120, 130, as in the system of FIG. 3. Let [symbol] ₘ denote a set of RU indices where RU l∈ [symbol] ₘ means RU l is connected to aggregation unit m for m=1, . . . , M. Each RU l is equipped with Nₗ antennas and serves Kₗ (Kₗ≤K) user layers. The indices of user layers served by RU l are denoted by set [symbol] ₗ for l=1, . . . , L. The set [symbol] ₗ can be determined based on the scheduling information. Note that in this context, RU l serving a certain user-layer k means that the channel between RU l and user-layer k is configured, e.g., by the BBU 110, to be estimated. The channel estimation can be performed by a respective channel estimation unit 541, 551, 561 of each RU. This channel estimation is used for serving the wireless communication to user-layer k. The desired DL channel between RU l and the Kₗ user layers is denoted as Hₗ∈ [symbol] ^{K}^{ₗ}^{×N}^{ₗ} for l=1, . . . , L. To be simplified and without losing generality, the denotation of channel Hₗ and its channel estimate Ĥₗ will not be differentiated in the following derivation. Only Hₗ will be used in mathematical explanation for convenience. The channel estimation determined at the channel estimation unit 541, 551, 561 of each RU 140, 150, 160 may be stored in a respective memory, e.g., channel state memory 542, 552, 562 of each RU, for reuse. Regarding the K user layers in the network, if a certain user layer k is not measured by RU l, i.e. the channel info will be not used by RU l, the channel between RU l and the user layer k can be denoted as 0^{T}, which is an 1×Nₗ zero vector. Define an extended channel matrix H̅ₗ∈ [symbol] ^{K×N}^{ₗ} that the k-th row of H̅ₗ is

$${\overline{H}}_{l} ( k , : ) = \{ \begin{matrix}{H}_{l} ( i , : ) & if k ∈ {ℛ}_{l} , and k = {ℛ}_{l} \{ i \} \\ {0}^{T} & if k ∉ {ℛ}_{l}\end{matrix} \qquad ( 1 )$$

For the BBU 110 to conduct centralized beamforming, it equivalently considers that the L RUs form a large antenna array. Without loss of generality, the effective channel of the large antenna array composed by all RUs can be expressed as

$$H = [ \begin{matrix}{\overline{H}}_{1} & … & {\overline{H}}_{L}\end{matrix} ] ∈ {ℂ}^{K \times ( {\sum }_{l = 1}^{L} {N}_{l} )}$$

To conduct centralized reciprocity-assisted transmission (RAT) in DL, the beamforming weights can be calculated as

$$W = {H}^{H} {\underbrace{{( {HH}^{H} + {δ}^{2} I )}^{- 1}}}_{{W}_{BBU}} = [ \begin{matrix}{\overline{H}}_{1}^{H} \\ ⋮ \\ {\overline{H}}_{L}^{H}\end{matrix} ] {W}_{BBU} , \qquad ( 2 )$$

where H^{H} is the Hermitian transpose of H, I is a K×K identity matrix, and δ² is a regularization factor that can be calculated, for example, based on the trace of HH^{H} as well as interference and noise power. When δ²=0, it is equivalent to a zero-forcing (ZF)-based beamforming.
Note that

$${HH}^{H} = [ \begin{matrix}{\overline{H}}_{1} & … & {\overline{H}}_{L}\end{matrix} ] [ \begin{matrix}{\overline{H}}_{1}^{H} \\ ⋮ \\ {\overline{H}}_{L}^{H}\end{matrix} ] = {\sum }_{l = 1}^{L} {\overline{H}}_{l} {\overline{H}}_{L}^{H}$$

and the element at row k and column k′ of matrix H̅ₗH̅ₗ^{H} is expressed as

$$[ {\overline{H}}_{l} {\overline{H}}_{l}^{H} ] ( k , {k}^{′} ) = \{ \begin{matrix}{H}_{l} ( i , : ) {H}_{l}^{H} ( : , j ) & if k = {ℛ}_{l} \{ i \} and {k}^{′} = {ℛ}_{l} \{ j \} \\ 0 & if k ∉ {ℛ}_{l} or {k}^{′} ∉ {ℛ}_{l}\end{matrix}$$

So essentially, H̅ₗH̅ₗ^{H} can be obtained by HₗHₗ^{H} the elements of which are placed in a K×K matrix indexed by [symbol] ₗ.

Thus, after obtaining the channel estimation of Hₗ at each channel estimation unit 541, 551, 561, the l-th part of intermediate BFWs Cₗ=HₗHₗ^{H} can be calculated at a local beamforming control unit 543, 553, 563 at each RU l. This is equivalent for both the first and the second alternative. Further for both alternatives, each RU 140, 150, 160 sends the calculated intermediate BFW Cₗ to its connected AU 120, 130, which is AU1 120 for RU1 140 and RU2 150, and AU M 130 for RU L 160. At each AU 120, 130, the received intermediate BFW are combined as

$${C}_{com , m} = {\sum }_{l ∈ {ℒ}_{m}} {\overline{H}}_{l} {\overline{H}}_{l}^{H}$$

$${C}_{com , m} ( k , {k}^{′} ) = {\sum }_{l ∈ {ℒ}_{m} , k = {ℛ}_{l} \{ i \} and {k}^{′} = {ℛ}_{l} \{ j \}} {H}_{l} ( i , : ) {H}_{l}^{H} ( : , j )$$

This combining may be performed in a first combiner 521 for the first AU 120 and in a second combiner 531 for the second AU 130. In the first combiner 521, the intermediate BFW coming from the RUs connected to the first AU 120 are combined and in the second combiner 531, the intermediate BFW coming from the RUs connected to the second AU 130 are combined. Note that in this process, the dimension of C_{com,m} is always K×K, i.e., it does not increase with respect to the number of connected RUs. After the combiner 521, 531 of the respective AU 120, 130 has combined the received intermediate BFWs, the combined intermediate BFWs C_{com,m} are sent by the respective AU 120, 130 to the BBU.

Further note that both Cₗ and C_{com,m} are Hermitian matrices which means Cₗ^{H}=Cₗ and C_{com,m} This means that only transporting the upper triangular or lower triangular components of the Hermitian matrix from the respective RU to its AU and from the respective AU to the BBU is enough to convey the information carried by the original matrix. The upper triangular components of the Hermitian matrix are composed by all the entries above and including the main diagonal entries. The lower triangular components of the Hermitian matrix are composed by all the entries below and including the main diagonal entries. This means that by sending only the upper or lower triangular components of the intermediate BFW matrix to the respective AU, the number of intermediate BFWs Cₗ that need to be transported from each RU to the connected AU is reduced from K₂ to (K₂+K₁)/2, without losing any information in the sending. Further in a similar way, if AU m receives the upper or lower triangular components of Cₗ from RU l, it only needs to calculate the upper or lower triangular components of C_{com,m} and sends them onwards. That is, also combined intermediate BFW that need to be transported from the respective AU 120, 130 to the BBU 110 can be reduced from K₂ to (K₂+K)/2.

Then, BBU 110 will receive from the one or more aggregation units 120, 130 the combined intermediate BFWs C_{com,1} C_{com,m}, respectively. If there is more than one set of combined intermediate BFWs received, the BBU 110 further calculates final combined intermediate BFWs as C_{com}=Σₘ₌₁^{M} C_{com,m}. This may be performed in a central beamforming control unit 511 of the BBU. If only the upper triangular components of C_{com}, denoted by C_{com,u} is obtained, the BBU further recovers C_{com} as

$${C}_{com} ( k , {k}^{′} ) = \{ \begin{matrix}{C}_{com , u} ( k , {k}^{′} ) & if k \leq {k}^{′} \\ {[ {C}_{com , u} ( {k}^{′} , k ) ]}^{*} & if k > {k}^{′}\end{matrix}$$

where [C_{com,u} (k′, k)]* denotes the complex conjugate of C_{com,u} (k′, k). If only the lower triangular components of C_{com}, denoted by C_{com,l} is received, the BBU recovers C_{com} as

$${C}_{com} ( k , {k}^{′} ) = \{ \begin{matrix}{[ {C}_{com , l} ( {k}^{′} , k ) ]}^{*} & if k < {k}^{′} \\ {C}_{com , l} ( k , {k}^{′} ) & if k \geq {k}^{′}\end{matrix}$$

Using the received or recovered C_{com}=HH^{H}, the BBU can also calculate the regularization factor δ², based on e.g. the average summation of the diagonal elements of C_{com}, and thereby the first part BFW as

$${W}_{BBU} = {( {HH}^{H} + {δ}^{2} I )}^{- 1} = {( {C}_{com} + {δ}^{2} I )}^{- 1}$$

In the first alternative of this embodiment, as shown in FIG. 7, the central beamforming control unit BBU 511 calculates the first part of BFW W_{BBU} as stated in the formula immediately above. Further, in the BBU 110, symbols of data streams of K user layers are coded in a coder 501 and modulated in a modulator 502 before they are mapped into resource elements (RE) in a RE mapper 503. The RE mapped data streams of the K user layers are then intermediately beamformed in a BBU beamformer 512 using the first part of BFWs W_{BBU} calculated by the beamforming control unit 511 to conduct the first part beamforming of the K user layer signals. In other words, a first part of beamforming of the user layer signals is performed in the BBU. In this way, the number of DL User-Plane data streams is equal to the number of user layers K.

In the second alternative of this invention, as shown in FIG. 8, the central beamforming control unit 511 of the BBU 111 sends the calculated first part of BFWs W_{BBU} to the respective AU 120, 130. Since the first part of BFW W_{BBU} is also a Hermitian matrix, the fronthaul load of transporting W_{BBU} can also be saved by only transporting the upper or lower triangular components of first part of BFW W_{BBU}. In this case, the number of first part BFWs that needs to be transported from the BBU 110 to the respective AU 120, 130 is also reduced from K₂ to (K₂+K)/2. If only the upper or lower triangular components are received, each AU 120, 130 can recover the original first part of BFW W_{BBU} before further sending them to the connected RUs. Further, in the BBU 110, bits/symbols of data streams of K user layers are coded in a coder 501 and possibly also modulated in a not-shown modulator before they are sent in the DL from the BBU 110 to the respective RU 140, 150, 160 via a User Plane Controller, UP ctrl 522, 523 of the respective AU 120, 130. Here the number of DL User plane data streams is equal to the number of user layers K. As shown in Eq. (2) above, the effective BFWs applied on the user layer signals at RU (140, 150, 160 is H/W_{BBU}, where H̅ₗ^{H} can be obtained based on the local channel estimation determined by the channel estimation unit 541, 551, 561 of the respective RU (140, 150, 160. Since H̅ₗ^{H} has some zero-vector columns according to Eq. (1), it is equivalent to apply H̅ₗ^{H}\tilde{W}_{BBU,l}, where at RU l \tilde{W}_{BBU,l} is composed by Kₗ selected rows from W_{BBU} where the row indices are indicated by set [symbol] ₗ.

According again to the first alternative of this embodiment, which is shown in FIG. 7, the same intermediately beamformed K user-layer signals after the first part of beamforming conducted by the BBU beamformer 512 is transported from the BBU 110 to the UP ctrl 522, 532 of each AU 120, 130. According one variant, applying \tilde{W}_{BBU}, can be achieved by the AU m 120, 130 selecting Kₗ intermediately beamformed user-layer signals out of all the received intermediately beamformed signals according to the indices indicated by [symbol] ₗ. The selection of the Kₗ intermediately beamformed user layer signals may be performed by the respective UP ctrl 522, 523. The UP ctrl 522, 523 then sends the respective intermediately beamformed user layer signals to the RU l 140, 150, 160 for l∈ [symbol] ₘ. In the meantime, the local beamforming control 543, 553, 563 at each RU 140, 150 160 determines second part of BFW as a Hermitian transpose Hₗ^{H} of the local DL channel estimate Hₗ of the respective RU 140, 150, 160. An RU beamformer 544, 554, 564 at each respective RU l then conducts the second part beamforming of the intermediately beamformed Kₗ user-layer signals using the second part BFWs Hₗ^{H}.

According again to the second alternative of the embodiment shown in FIG. 8, a BFW control unit 523, 533 of each AU m 120, 130 constructs first part of BFW for the I-th RU \tilde{W}_{BBU}, based on the received first part of BFW W_{BBU} and the information of set [symbol] ₗ for l∈ [symbol] ₘ. The AU m 120, 130 then sends the first part of BFW for the I-th RU \tilde{W}_{BBU}, to the RU l. I. In the meantime, the local beamforming control 543, 553, 563 at each RU 140, 150 160 determines second part of BFW as a Hermitian transpose Hₗ^{H} of the local DL channel estimate Hₗ of the respective RU 140, 150, 160. And then the local beamforming control 543, 553, 564 at each RU l 140, 150, 160 calculates final BFWs as Hₗ^{H}\tilde{W}_{BBU,l}. Also, the respective DL user-layer signals adapted for each RU is received at the respective RU and modulated in a modulator 546, 556, 566 and mapped to resource elements in a RE mapper 547, 557, 567 of the respective RU 140, 150, 160 before the DL user-layer signals for the respective RU are beamformed in the RU beamformer 544, 554, 564 of the respective RU 140, 150, 160 based on the final BFW.

Thereafter, for both the first and the second alternative, the beamformed user layer signals for each RU are transformed from frequency domain to time domain and from baseband to radio frequency in an Inverse Fast Fourier Transform (IFFT) and Radio Frequency (RF) unit 545, 555, 565 of the respective RU 140, 150, 160 before the RF signals are transmitted wirelessly towards the UEs.

By doing so, a method is provided for conducting centralized beamforming which applies Eq. (2) without requiring transporting all instantaneous channel estimate of Hₗ for l=1, . . . , L obtained by the respective RU 140, 150, 160 to the BBU 110, which imposes much higher requirement on the AUs and FH interfaces, compared to that of the presented method.

In the following, different method embodiments performed by a first RU of a distributed base station system is described. The first RU comprises N₁ antennas. The distributed base station system further comprises a first AU connected to the first RU over a fronthaul link and connected to a second RU over a fronthaul link, the second RU comprising N₂ antennas. The distributed base station system further comprises a BBU connected to the first AU over a fronthaul link. The method comprises obtaining a first DL channel estimate of the first RU, denoted as Ĥ₁. The first channel estimate is between the first RU and a number of user layers, the size of which is denoted K₁. The first channel estimate is based on reference signals, for example, sounding reference signal, SRS, transmitted by the UEs served by the first RU. The method may further comprise storing the channel estimate in a channel state memory. The method further comprises determining a first part of intermediate BFW C₁ to be used for centralized interference mitigation based on the first channel estimate Ĥ₁. The first part of intermediate BFW may be determined as C₁=Ĥ₁Ĥ₁^{H}. The first part of intermediate BFW may additionally be determined based on interferences experienced by other cells from signals sent by the first RU. The method further comprises sending, to the first AU, the first part of intermediate BFW C₁. In one embodiment, the sent intermediate BFWs only contain the upper triangular components or lower triangular components of the first part of intermediate BFW C₁.

The method further comprises receiving, from the first AU, downlink data streams to be sent to a number of UEs. In one embodiment, the downlink data streams comprise frequency-domain complex symbols that have been intermediately beamformed by the BBU. In another embodiment, the downlink data streams comprise coded bits. In this case, the first RU further conducts modulation and RE mapping. In yet another embodiment, the downlink data streams comprise modulated symbols. The method further comprises determining second part of BFW based on the first channel estimate Ĥ₁ stored in the channel state memory. In one embodiment, the second part of BFW is the Hermitian transpose of the first channel estimate Ĥ₁^{H}. Further, the second part of BFW are used to perform maximum ratio transmission (MRT) as a second part of frequency-domain beamforming. In another embodiment, the method further comprising receiving a first part of BFW from the first AU, and calculating final BFW based on both the second part of BFW and the first part of BFW. Thereafter, the method comprises conducting frequency-domain beamforming based on the calculated final BFW and the received user-layer IQ data on respective subcarrier by multiplying the IQ data with the BFWs on the respective subcarriers. The method further comprises sending the beamformed signals to the next step of the transmitter.

In the following, different method embodiments performed by a first AU of a distributed base station system is described. The method comprises receiving scheduling information from a scheduler of the BBU comprising information indicating user layers to be transmitted in the next TTI for each of RUs connected to the first aggregation unit, and which user layers will be served by each RU. The method further comprises receiving, from both the first and the second RU, their respective intermediate BFW as C₁ and C₂ to be used for centralized interference cancellation at the BBU. The first intermediate BFW C₁ are determined by the first RU based on the first channel estimate Ĥ₁. The second intermediate BFW C₂ are determined by the second RU based on the second channel estimate Ĥ₂. In one embodiment, the received intermediate BFW are composed only by the upper triangular components or the lower triangular components. The method further comprises combining the received intermediate BFW including the first intermediate BFW C₁ and the second intermediate BFW C₂ into combined intermediate BFW C_{com,1}. When both the row dimension of Ĥ₁, i.e., K₁ and the row dimension of Ĥ₂, i.e., K₂, are equal to the total number of user layers K served by the BBU, the combining is done by directly adding C₁ and C₂. When either the row dimension of Ĥ₁, i.e., K₁ or the row dimension of Ĥ₂, i.e., K₂, is smaller than the total number of user layers served by the BBU, the combining is done by adding the elements of C₁ to some elements of C₂. The corresponding index information of where the addition is performed is indicated by the received scheduling information. When the received intermediate BFW only contain the upper triangular components or lower triangular components, the combining is done based on the upper triangular components or lower triangular components of C₁ and C₂, and results in upper triangular components or lower triangular components. The method further comprises sending, to the BBU, the combined intermediate BFW C_{com,1}. In one embodiment, the sent combined intermediate BFW only contain the upper triangular components or lower triangular components.

Then the method further comprises receiving, from the BBU, downlink data streams to be sent to a number of UEs. In a first embodiment, the downlink data streams comprise frequency-domain complex symbols after first part of frequency-domain beamforming conducted in the BBU based on the combined intermediate BFW. In a second embodiment, the downlink data streams comprise coded bits. In this case, the first RU further conducts modulation and RE mapping. In a variant of the second embodiment, the downlink data streams comprise modulated symbols. Further, the method comprises sending, to the first RU and the second RU respectively, downlink data streams to be sent to a number of UEs. In the first embodiment, the downlink data streams comprise frequency-domain complex symbols after the first part of beamforming, aka intermediate beamforming, conducted in the BBU. The second part of beamforming will then take part in the respective first and second RU. In the second embodiment, the received downlink data streams have not been intermediately beamformed in the BBU. Further, and possible in any of the first and second embodiment, the method may comprise extracting K₁ user-layer data streams out of the K received data streams to be sent to the first RU and extracting K₂ user-layer data streams out of the K received data streams to be sent to the second RU. The identification of K₁ user-layer for the first RU and K₂ user-layer for the second RU is based on the received scheduling information from the BBU. Further, in the second embodiment, the method further comprising receiving, from the BBU, a first part of BFW W_{BBU}, and sending, to the first RU and the second RU respectively, information of the first part BFW W_{BBU}. The respective first and second RU will then use the first part of BFW to perform beamforming using the first part of BFW and second part of BFW. In one embodiment, the received first part BFW are composed by the upper triangular components or lower triangular components of W_{BBU}. In this case, the method optionally further comprises recovering in the first AU an original first part BFWs W_{BBU}. The recovering can be based on the Hermitian symmetric property of W_{BBU}. In the second embodiment, the method optionally further comprising sending W_{BBU,1} to the first RU and W_{BBU,2} to the second RU, respectively, where W_{BBU,1} is composed by K₁ selected rows from W_{BBU} and W_{BBU,2} is composed by K₂ selected rows from W_{BBU}. In other words, only the first part of BFW that are relevant to the first RU is sent to the first RU and only the first part of BFW that are relevant to the second RU are sent to the second RU. Index information of which rows are selected to which RU is indicated by the received scheduling information from the BBU.

In the following, different method embodiments performed by a BBU system of a wireless communication network is described. The wireless communication network comprises a distributed base station system having a BBU, a first AU connected to the BBU over a BBU fronthaul link, a first RU connected to the first AU over a first AU fronthaul link, the first RU comprising N₁ antennas, and a second RU connected to the first AU over a second AU fronthaul link, the second RU comprising N₂ antennas. The method comprises sending scheduling information to the first AU, the scheduling information comprising information indicating user layers to be transmitted in the next TTI for each of the connected RU of the first AU and which user layers will be served by each RU. The method further comprises receiving, from the first AU, combined intermediate BFW C_{com,1} based on a first part of intermediate BFWs C₁, and a second part of intermediate BFW C₂, the first part of intermediate BFW C₁ being determined by the first RU based on a first channel estimate Ĥ₁ of wireless communication channels H₁ in the frequency domain between the N₁ antennas and a number of UEs, the second part of intermediate BFW C₂ being determined by the second RU based on a second channel estimate Ĥ₂ of wireless communication channels H₂ in the frequency domain between the N₂ antennas and a number of UEs. According to an embodiment, if the received combined intermediate BFW only contain the upper triangular components or lower triangular components, the method further comprises recovering an original combined intermediate BFWs C_{com,1}. The recovering can be based on the Hermitian symmetric property of C_{com,1}. In case the BBU receives more than one set of combined intermediate BFW from more than one AU, that is in case there are more than one AU connected to the BBU, the method further comprising combining the received combined intermediate BFWs from the more than one AU and obtain final combined intermediate BFW C_{com}. If the final combined intermediate BFW only contain the upper triangular components or lower triangular components, the method further comprises recovering an original final combined intermediate BFWs C_{com}. The recovering can be based on the Hermitian symmetric property of C_{com}.

The method further comprises determining the first part of BFWs W_{BBU} based on the final combined intermediate BFWs C_{com}. If the BBU only receives one set of combined intermediate BFW, for example if there is only one AU connected to the BBU, C_{com}=C_{com,1}. According to an embodiment, the first part of BFWs can be determined by W_{BBU}=(C_{com}+δ²I)⁻¹, where δ² is a regularization factor which may be determined based on C_{com} and I is a K×K identity matrix. δ² can be set to 0. The method further comprises sending, to the first AU, K user-layer downlink data streams to be sent to a number of UEs, where K is the total number of user layers served by the BBU. In the first embodiment, the method further comprises determining K beamformed user-layer downlink data streams based on the first part of BFWs W_{BBU} and modulated symbols of K user layers in downlink. In this case, the downlink data streams comprise intermediately-beamformed frequency-domain complex symbols. In the second embodiment, the K user-layer data streams have not been intermediately-beamformed and may comprise coded bits or modulated symbols. In the second embodiment, the BBU further sends the first part of BFW W_{BBU} to the first AU.

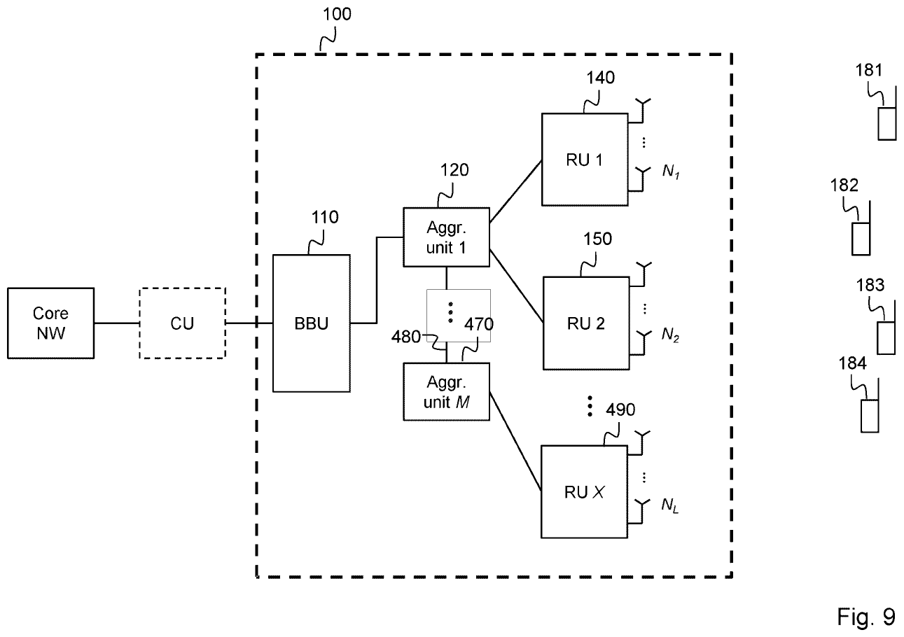

FIG. 9 describes an alternative architecture in which the distributed base station system 100 further comprises a cascade-coupled AU 470 connected to the first AU 120 via an AU-AU FH link 480. The cascade-coupled AU 470 is also connected to one or more other RUs 490 from which it receives intermediate BFW determined by respective ones of the one or more other RUs 490. This means that the cascade-coupled AU 470 is connected to the BBU 110 via the first AU 120. In this case, the first AU 120 additionally performs receiving, from the cascade-coupled AU 470 other combined intermediate BFW that the cascade-couple AU 470 has combined from intermediate BFW it has received from its one or more other RUs 490, secondly combining the other combined intermediate BFW received from the cascade-coupled AU with the intermediate BFW received from the first and second RUs 140, 150, and sending, to the BBU, the secondly combined intermediate BFW. In case there are many cascade-coupled AUs, such as the first AU would be in its turn cascade-coupled to another AU, the first AU sends its secondly combined intermediate BFW to the another AU that in its turn makes another combination of intermediate BFW that are to be sent to the BBU.

Thereafter, the first AU 120 receives, from the previous unit in the downlink direction of the cascaded chain, i.e. the BBU 110 when the first AU is connected directly to the first BBU or the another AU when the first AU in its turn is cascade-coupled to the another AU, K user-layer downlink data streams to be sent to a number of UEs, where K is the total number of user layers served by the BBU. The first AU 120 then forwards the K user-layer downlink data streams to the cascade-coupled AU 470. In the first embodiment, the K user-layer downlink data streams have been intermediately beamformed based on the intermediate BFW. In the second embodiment, no beamforming has been performed on the received K user-layer downlink data streams. In the second embodiment, the method further comprises receiving from the previous unit in the downlink direction of the cascaded chain, a first part BFWs W_{BBU} determined based on the intermediate BFW and forwarding the first part BFWs W_{BBU} to the cascade-coupled AU 470.

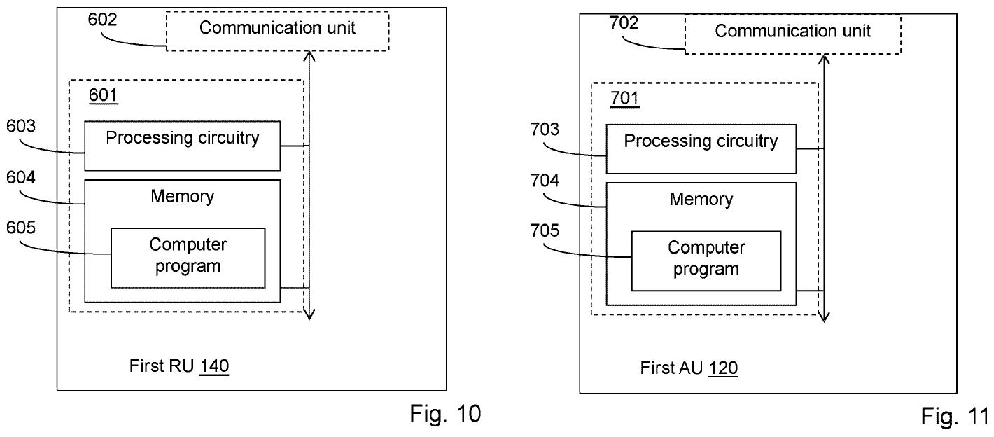

FIG. 10, in conjunction with FIG. 3, shows a first RU, 140 configured to operate in a distributed base station system 100. The first RU 140 comprises N₁ antennas 141, 142. The distributed base station system 100 further comprises a first AU 120 connected to the first RU 140 via a first AU FH link 145 and a second RU 150 connected to the first AU 120 via a second AU FH link 155. The second RU 150 comprises N₂ antennas 151, 152. The distributed base station system 100 further comprises a BBU 110 connected to the first AU 120 over a first BBU FH link 115. The first RU 140 comprises a processing circuitry 603 and a memory 604. Said memory contains instructions executable by said processing circuitry, whereby the first RU 140 is operative for obtaining a first downlink, DL, channel estimate Ĥ₁ of a communication channel between the first RU 140 and a first number of UEs 181, 182, 183, determining first intermediate beamforming weights, BFW, C₁ to be used for centralized interference mitigation, based on the first DL channel estimate Ĥ₁ and sending, to the first AU 120, at least a part of the determined first intermediate BFW C₁. According to a first alternative, the first RU 140 is further operative for receiving, from the first AU 120, intermediately-beamformed DL data streams of first user layers K₁ of the first number of UEs 181, 182, 183 intermediately beamformed based on first part of BFW W_{BBU} determined based on an inverse calculation of at least a combination C_{com} of the first intermediate BFW C₁ and second intermediate BFW C₂, determined to be used for centralized interference mitigation based on a second DL channel estimate Ĥ₂ of a communication channel between the second RU 150 and a second number of UEs 182, 183, 184, obtaining second part of BFW based on the first DL channel estimate Ĥ₁, and beamforming the received intermediately-beamformed DL data streams of the first user layers K₁ based on the second part of BFW into beamformed DL data streams for the first user layers K₁. According to a second alternative, the first RU 140 is further operative for receiving, from the first AU 120, DL data streams of the first user layers K₁ and receiving first part of BFW W_{BBU,1} for the first user layers K₁ comprising an inverse calculation of at least the combination C_{com} of the first intermediate BFW C₁ and the second intermediate BFW C₂, and determining final BFW based on the first part of BFW W_{BBU,1} for the first user layers and based on the first DL channel estimate, and beamforming the received DL data streams of the first user layers K₁ based on the determined final BFW into beamformed DL data streams for the first user layers K₁. After either the first or the second alternative, the first RU is operative for transmitting the beamformed DL data streams of the first user layers K₁ to the first number of UEs 181, 182, 183.

According to an embodiment, the first RU 140 is operative for obtaining the second part of BFW as a as a Hermitian transpose Ĥₗ^{H} of the first DL channel estimate Ĥ₁, and/or for determining the final BFW based on the first part of BFW W_{BBU,1} for the first user layers and based on the Hermitian transpose Ĥₗ^{H} of the first DL channel estimate.

According to an embodiment, the first RU 140 is operative for storing information on the first DL channel estimate Ĥ₁.

According to another embodiment, the at least part of first intermediate BFW C₁ that are sent to the first AU comprises only a subset of the first intermediate BFW C₁ that can be used by the first AU for recovering full first intermediate BFW.

According to another embodiment, the first RU 140 is further operative for obtaining, from neighboring cells, information on interference experienced at neighboring cells from DL signals sent by the first RU, and operative for determining the first intermediate BFW C₁ also based on the obtained information on interference.

According to another embodiment, the first RU 140 is operative for determining the first intermediate BFW C₁ based on Ĥ₁Ĥ₁^{H}, where Ĥ₁^{H} is a Hermitian transpose of the first DL channel estimate Ĥ₁.

According to another embodiment, the first RU 140 is further operative for receiving, from the first AU, scheduling information comprising information on the first user layers K₁ to be transmitted in a TTI by the first RU 140. Further, the first RU is operative for receiving, from the first AU 120, intermediately-beamformed DL data streams by receiving intermediately-beamformed data streams of the first and the second user layers K₁, K₂, and the first RU is further operative for selecting, for the beamforming, only the intermediately-beamformed DL data streams of the first user layers K₁ from the received intermediately-beamformed DL data streams of the first and the second user layers K₁ K₂ based on the received scheduling information.

According to another embodiment, the first RU 140 is further operative for receiving, from the first AU, scheduling information comprising information on the first user layers K₁ to be transmitted in a TTI by the first RU 140. Further, the first RU is operative for receiving, from the first AU 120, of the DL data streams of the first user layers K₁ and the first part of BFW W_{BBU,1} that are scheduled to the first RU by receiving the DL data streams of the first and second user layers K₁ K₂ and the first part of BFW W_{BBU} that are scheduled to the first and second RU, and the first RU is further operative for selecting, for the determining 213 and the beamforming 214, only the DL data streams of the first user layers K₁ and the first part of BFW W_{BBU,1} that are scheduled to the first RU based on the received scheduling information.

According to other embodiments, the first RU 140 may further comprise a communication unit 602, which may be considered to comprise conventional means for wireless communication with the UEs 181, 182, 183, such as a transceiver for wireless transmission and reception of signals in the communication network. The communication unit 602 may also comprise conventional means for communication with the first AU 120 over the first AU FH link 145. The instructions executable by said processing circuitry 603 may be arranged as a computer program 605 stored e.g. in said memory 604. The processing circuitry 603 and the memory 604 may be arranged in a sub-arrangement 601. The sub-arrangement 601 may be a micro-processor and adequate software and storage therefore, a Programmable Logic Device, PLD, or other electronic component(s)/processing circuit(s) configured to perform the methods mentioned above. The processing circuitry 603 may comprise one or more programmable processor, application-specific integrated circuits, field programmable gate arrays or combinations of these adapted to execute instructions.

The computer program 605 may be arranged such that when its instructions are run in the processing circuitry, they cause the first RU 140 to perform the steps described in any of the described embodiments of the first RU 140 and its method. The computer program 605 may be carried by a computer program product connectable to the processing circuitry 603. The computer program product may be the memory 604, or at least arranged in the memory. The memory 604 may be realized as for example a RAM (Random-access memory), ROM (Read-Only Memory) or an EEPROM (Electrical Erasable Programmable ROM). In some embodiments, a carrier may contain the computer program 605. The carrier may be one of an electronic signal, an optical signal, an electromagnetic signal, a magnetic signal, an electric signal, a radio signal, a microwave signal, or computer readable storage medium. The computer-readable storage medium may be e.g. a CD, DVD or flash memory, from which the program could be downloaded into the memory 604. Alternatively, the computer program may be stored on a server or any other entity to which the first RU 140 has access via the communication unit 602. The computer program 605 may then be downloaded from the server into the memory 604.

FIG. 11, in conjunction with FIG. 3, shows a first AU 120 configured to operate in a distributed base station system 100. The distributed base station system 100 further comprises a first RU 140 comprising N₁ antennas 141, 142, the first RU 140 being connected to the first AU 120 via a first AU FH link 145, and a second RU 150 comprising N₂ antennas 151, 152, the second RU being connected to the first AU 120 via a second AU FH link 155. The distributed base station system 100 further comprises a BBU 110 connected to the first AU 120 over a first BBU FH link 115. The first AU 120 comprises a processing circuitry 703 and a memory 704. Said memory contains instructions executable by said processing circuitry, whereby the first AU 120 is operative for receiving, from the first RU 140 over the first AU FH link 145, at least a part of first intermediate BFW C₁ determined to be used for centralized interference mitigation based on a first DL channel estimate Ĥ₁ of a communication channel between the first RU 140 and a first number of UEs 181, 182, 183, and receiving, from the second RU 150 over the second AU FH link 155, at least a part of second intermediate BFW C₂ determined to be used for centralized interference mitigation based on a second DL channel estimate Ĥ₂ of a communication channel between the second RU 150 and a second number of UEs 182, 183, 184. The first AU 120 is further operative for combining the at least part of first intermediate BFW C₁ with the at least part of second intermediate BFW C₂ into combined intermediate BFW C_{com}, and sending, to the BBU 110 over the first BBU FH link 115, the combined intermediate BFW C_{com}. According to a first alternative, the first AU 120 is operative for receiving, from the BBU 110, intermediately-beamformed DL data streams of first user layers K₁ of the first number of UEs 181, 182, 183 and of second user layers K₂ of the second number of UEs 182, 183, 184, the DL data streams being intermediately beamformed based on an inverse calculation of at least the combined intermediate BFW C_{com}, sending at least the intermediately-beamformed DL data streams of the first user layers to the first RU 140 and sending at least the intermediately-beamformed DL data streams of the second user layers to the second RU 150. According to a second alternative, the first AU 120 is operative for receiving, from the BBU 110, the DL data streams of the first and second user layers K₁, K₂, and at least a part of first part of BFW W_{BBU} determined based on an inverse calculation of at least the combined intermediate BFW C_{com}, sending to the first RU 140, at least the DL data streams of the first user layers K₁ and at least the first part of BFW W_{BBU,1} that are scheduled to the first RU and sending to the second RU 150, at least the DL data streams of the second user layers K₂ and at least the first part of BFW W_{BBU,2} that are scheduled to the second RU.

According to an embodiment, the first AU 120 is further operative for receiving, from the BBU 110, scheduling information comprising information on the first user layers K₁ to be transmitted in a TTI by the first RU 140 and on the second user layers K₂ to be transmitted in the TTI by the second RU 150, and sending the received scheduling information to the first RU and the second RU. Also, the first AU is operative for sending of at least the intermediately-beamformed DL data streams of the first user layers to the first RU and for sending of at least the intermediately-beamformed DL data streams of the second user layers to the second RU by sending the first and the second intermediately-beamformed DL data streams of the first and the second user layers to both the first and the second RU.

According to another embodiment, the first AU 120 is further operative for receiving, from the BBU 110, scheduling information comprising information on the first user layers K₁ to be transmitted in a TTI by the first RU 140 and on the second user layers K₂ to be transmitted in the TTI by the second RU 150, and extracting the intermediately-beamformed DL data streams of the first user layers K₁ and the intermediately-beamformed DL data streams of the second user layers K₂. Also, the first AU is operative for sending of at least the intermediately-beamformed DL data streams of the first user layers to the first RU by sending only the extracted intermediately-beamformed DL data streams of the first user layers K₁ to the first RU, and for sending of at least the intermediately-beamformed DL data streams of the second user layers to the second RU by sending only the extracted intermediately-beamformed DL data streams of the second user layers K₂ to the second RU.

According to another embodiment, the at least part of first intermediate BFW C₁ that are received from the first RU comprises only a subset of the first intermediate BFW C₁, and the at least part of second intermediate BFW C₂ that are received from the second RU comprises only a subset of the second intermediate BFW C₂. Further, the first AU is operative for combining of the at least one first intermediate BFW C₁ with the at least one second intermediate BFW C₂ into combined intermediate BFW C_{com} by combining the subset of the first intermediate BFW with the subset of the second intermediate BFW. Also, the first AU is operative for sending of the combined intermediate BFW C_{com} by sending the combination of the subset of the first intermediate BFW with the subset of the second intermediate BFW to the BBU 110.

According to another embodiment, the at least a part of first part of BFW W_{BBU} that are received from the BBU 110 comprises only a subset of the first part of BFW W_{BBU}. Further, the first AU is operative for recovering the whole first part of BFW from the subset of the first part of BFW W_{BBU} based on Hermitian symmetry property of the first part of BFW W_{BBU}.

According to another embodiment, the distributed base station system 100 further comprises a cascade-coupled AU 470 connected to the first AU 120 via an AU-AU FH link 480, the cascade-coupled AU 470 being also connected to one or more other RUs 490 from which it is arranged to receive intermediate BFW determined by respective ones of the one or more other RUs 490. Further, the first AU 120 is operative for receiving, from the cascade-coupled AU 470 over the AU-AU FH link 480, other combined intermediate BFW that the cascade-coupled AU 470 has combined based on the intermediate BFW it has received from its one or more other RUs 490, and wherein the first AU is operative for combining of intermediate BFW by also combining the received other combined intermediate BFW with the at least part of first and the at least part of second intermediate BFW into the combined intermediate BFW that are to be sent to the BBU 110.

According to other embodiments, the first AU 120 may further comprise a communication unit 702, which may be considered to comprise conventional means for communication with the first and second RUs 140, 150 over the first and second AU FH link 145, 155, respectively, as well as for communication with the BBU 110 over the BBU FH link 115. The instructions executable by said processing circuitry 703 may be arranged as a computer program 705 stored e.g. in said memory 704. The processing circuitry 703 and the memory 704 may be arranged in a sub-arrangement 701. The sub-arrangement 701 may be a micro-processor and adequate software and storage therefore, a Programmable Logic Device, PLD, or other electronic component(s)/processing circuit(s) configured to perform the methods mentioned above. The processing circuitry 703 may comprise one or more programmable processor, application-specific integrated circuits, field programmable gate arrays or combinations of these adapted to execute instructions.

The computer program 705 may be arranged such that when its instructions are run in the processing circuitry, they cause the first AU 120 to perform the steps described in any of the described embodiments of the first AU 120 and its method. The computer program 705 may be carried by a computer program product connectable to the processing circuitry 703. The computer program product may be the memory 704, or at least arranged in the memory. The memory 704 may be realized as for example a RAM, ROM or an EEPROM. In some embodiments, a carrier may contain the computer program 705. The carrier may be one of an electronic signal, an optical signal, an electromagnetic signal, a magnetic signal, an electric signal, a radio signal, a microwave signal, or computer readable storage medium. The computer-readable storage medium may be e.g. a CD, DVD or flash memory, from which the program could be downloaded into the memory 704. Alternatively, the computer program may be stored on a server or any other entity to which the first AU 120 has access via the communication unit 702. The computer program 705 may then be downloaded from the server into the memory 704.

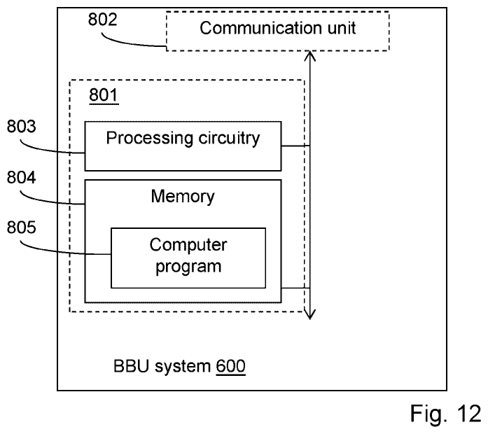

FIG. 12, in conjunction with FIG. 3, describes a BBU system 600 configured to operate in a wireless communication system. The wireless communication system comprises a distributed base station system 100. The distributed base station system 100 comprises a BBU 110, a first AU120 connected to the BBU 110 over a first BBU FH link 115, a first RU 140 comprising N₁ antennas 141, 142, the first RU 140 being connected to the first AU 120 via a first FH link 145, and a second RU 150 comprising N₂ antennas 151, 152, the second RU being connected to the first AU 120 via a second FH link 155. The BBU system 600 comprises a processing circuitry 803 and a memory 804. Said memory contains instructions executable by said processing circuitry, whereby the BBU system 600 is operative for receiving, from the first AU 120, combined intermediate BFW C_{com} comprising at least part of first intermediate BFW C₁ combined with at least part of second intermediate BFW C₂, the at least part of first intermediate BFW C₁ originating from the first RU 140 and being determined to be used for centralized interference mitigation based on a first DL channel estimate Ĥ₁ of a communication channel between the first RU 140 and a first number of UEs 181, 182, 183, the at least part of second intermediate BFW C₂ originating from the second RU 150 and being determined to be used for centralized interference mitigation based on a second DL channel estimate Ĥ₂ of a communication channel between the second RU 150 and a second number of UEs 182, 183, 184. The BBU system 600 is further operative for sending, to the first AU 120, scheduling information comprising information on first user layers K₁ of the first number of UEs 181, 182, 183 to be transmitted in a time transmission interval, TTI, by the first RU 140 and information on second user layers K₂ of the second number of UEs 182, 183, 184 to be transmitted in the TTI by the second RU 150 and determining first part of BFW W_{BBU} based on an inverse calculation of at least the received combined intermediate BFW C_{com}. According to a first alternative, the BBU system 600 is further operative for performing an intermediate beamforming on DL data streams of the first and second user layers K₁ K₂, based on the first part of BFW W_{BBU}, and sending the intermediately-beamformed DL data streams of the first and second user layers K₁ K₂ to the first AU 120. According to a second alternative, the BBU system 600 is further operative for sending, to the first AU 120, at least a part of the determined first part of BFW W_{BBU} and the DL data streams of the first and second user layers K₁ K₂.

The BBU system 600 may be arranged at or in the BBU 110. Alternatively, the BBU system 600 may be arranged at or in any other network node of the wireless communication network 100. Alternatively, the BBU system 600 may be realized as one or more network entities or a group of network nodes, wherein functionality of the BBU system 600 is spread out over the one or more network entities group of network nodes. The group of network nodes may be different physical, or virtual, nodes of the network. This latter alternative realization may be called a cloud-solution.

According to an embodiment, the BBU system 600 is operative for receiving the combined intermediate BFW C_{com} as only a subset of the combined intermediate BFW. Further, the BBU system is operative for recovering the combined intermediate BFW from the subset based on Hermitian symmetry property of the combined intermediate BFW C_{com}.

According to another embodiment, the at least a part of the first part of BFW W_{BBU} that is sent to the first AU 120 comprises only a subset of the first part of BFW W_{BBU}.

According to another embodiment, the BBU system 600 is operative for determining of first part of BFW W_{BBU} also based on interference experienced at neighboring cells, so that the first part of BFW is calculated as the inverse of the combined intermediate BFW added with a factor based on the experienced interference.

According to another embodiment, the factor is a regularization term δ₂I where I is an identity matrix and δ₂ is a regularization factor that is based on an estimate of power of interference and noise.

According to another embodiment, the distributed base station system 100 further comprises a second AU 130 connected to the BBU 110 via a second BBU FH link 125, the second AU 130 being also connected to one or more second AU RUs 160. Further, the BBU system is operative for receiving, from the second AU 130, second AU intermediate BFW originating from the one or more second AU RUs 160 and being determined to be used for centralized interference mitigation based on DL channel estimates of communication channels between the one or more second AU RUs 160 and a third number of UEs connected to the one or more second AU RUs 160, and combining the combined intermediate BFW received from the first AU 120 with the second AU intermediate BFW received from the second AU 130 into finally combined intermediate BFW. Also, the BBU system is operative for determining of the first part of BFW W_{BBU} based on an inverse calculation of at least the finally combined intermediate BFW.

According to other embodiments, the BBU system 600 may further comprise a communication unit 802, which may be considered to comprise conventional means for communication within the wireless communication network. The instructions executable by said processing circuitry 803 may be arranged as a computer program 805 stored e.g. in said memory 804. The processing circuitry 803 and the memory 804 may be arranged in a sub-arrangement 801. The sub-arrangement 801 may be a micro-processor and adequate software and storage therefore, a Programmable Logic Device, PLD, or other electronic component(s)/processing circuit(s) configured to perform the methods mentioned above. The processing circuitry 803 may comprise one or more programmable processor, application-specific integrated circuits, field programmable gate arrays or combinations of these adapted to execute instructions.

The computer program 805 may be arranged such that when its instructions are run in the processing circuitry, they cause the BBU system 600 to perform the steps described in any of the described embodiments of the BBU system 600 and its method. The computer program 805 may be carried by a computer program product connectable to the processing circuitry 803. The computer program product may be the memory 804, or at least arranged in the memory. The memory 804 may be realized as for example a RAM, ROM or an EEPROM. In some embodiments, a carrier may contain the computer program 805. The carrier may be one of an electronic signal, an optical signal, an electromagnetic signal, a magnetic signal, an electric signal, a radio signal, a microwave signal, or computer readable storage medium. The computer-readable storage medium may be e.g. a CD, DVD or flash memory, from which the program could be downloaded into the memory 804. Alternatively, the computer program may be stored on a server or any other entity to which the BBU system 600 has access via the communication unit 802. The computer program 805 may then be downloaded from the server into the memory 804.

Although the description above contains a plurality of specificities, these should not be construed as limiting the scope of the concept described herein but as merely providing illustrations of some exemplifying embodiments of the described concept. It will be appreciated that the scope of the presently described concept fully encompasses other embodiments which may become obvious to those skilled in the art, and that the scope of the presently described concept is accordingly not to be limited. Reference to an element in the singular is not intended to mean “one and only one” unless explicitly so stated, but rather “one or more.” All structural and functional equivalents to the elements of the above-described embodiments that are known to those of ordinary skill in the art are expressly incorporated herein by reference and are intended to be encompassed hereby. Moreover, it is not necessary for an apparatus or method to address each and every problem sought to be solved by the presently described concept, for it to be encompassed hereby. In the exemplary figures, a broken line generally signifies that the feature within the broken line is optional.

1. A method performed by a first radio unit, RU, of a distributed base station system, the first RU comprising N₁ antennas, the distributed base station system further comprising a first aggregation unit, AU, connected to the first RU via a first AU fronthaul, FH, link and a second RU connected to the first AU via a second AU FH link, the second RU comprising N₂ antennas, the distributed base station system further comprising a baseband unit, BBU, connected to the first AU over a first BBU FH link, the method comprising:
obtaining a first downlink, DL, channel estimate Ĥ₁ of a communication channel between the first RU and a first number of UEs;
determining first intermediate beamforming weights, BFW, C₁ to be used for centralized interference mitigation, based on the first DL channel estimate Ĥ₁;
sending, to the first AU, at least a part of the determined first intermediate BFW C₁;
receiving, from the first AU, one of:
intermediately-beamformed DL data streams of first user layers K₁ of the first number of UEs intermediately beamformed based on first part of BFW W_{BBU} determined based on an inverse calculation of at least a combination C_{com} of the first intermediate BFW C₁ and second intermediate BFW C₂, determined to be used for centralized interference mitigation based on a second DL channel estimate Ĥ₂ of a communication channel between the second RU and a second number of UEs, obtaining second part of BFW based on the first DL channel estimate Ĥ₁, and beamforming the received intermediately-beamformed DL data streams of the first user layers K₁ based on the second part of BFW into beamformed DL data streams for the first user layers K₁, and
DL data streams of the first user layers K₁ and receiving first part of BFW W_{BBU,1} for the first user layers K₁ comprising an inverse calculation of at least the combination C_{com} of the first intermediate BFW C₁ and the second intermediate BFW C₂, and determining final BFW based on the first part of BFW W_{BBU,1} for the first user layers and based on the first DL channel estimate, and beamforming the received DL data streams of the first user layers K₁ based on the determined final BFW into beamformed DL data streams for the first user layers K₁; and
transmitting the beamformed DL data streams of the first user layers K₁ to the first number of UEs.

2. The method of claim 1, wherein one of:
the second part of BFW are obtained as a as a Hermitian transpose Ĥ₁^{H} of the first DL channel estimate Ĥ₁, and
the final BFW are determined based on the first part of BFW W_{BBU,1} for the first user layers and based on the Hermitian transpose Ĥ₁^{H} of the first DL channel estimate.

3. The method of claim 1, further comprising:
storing information on the first DL channel estimate Ĥ₁.

4. The method of claim 1, wherein the at least part of first intermediate BFW C₁ that are sent to the first AU comprises only a subset of the first intermediate BFW C₁ that can be used by the first AU for recovering full first intermediate BFW.

5. The method of claim 1, further comprising:
obtaining, from neighboring cells, information on interference experienced at neighboring cells from DL signals sent by the first RU; and
wherein the first intermediate BFW C₁ are determined also based on the obtained information on interference.

6. The method of claim 1, wherein the first intermediate BFW C₁ are determined based on Ĥ₁Ĥ₁^{H}, where Ĥ₁^{H} is a Hermitian transpose of the first DL channel estimate Ĥ₁.

7. The method of claim 1, further comprising:
receiving, from the first AU, scheduling information comprising information on the first user layers K₁ to be transmitted in a time transmission interval, TTI, by the first RU; and
when receiving, from the first AU, the intermediately-beamformed DL data streams, the intermediately-beamformed DL data streams comprises intermediately-beamformed data streams of the first and the second user layers K₁, K₂, and selecting, for the beamforming, only the intermediately-beamformed DL data streams of the first user layers K₁ from the received intermediately-beamformed DL data streams of the first and the second user layers K₁, K₂ based on the received scheduling information.

8. The method of claim 1, further comprising:
receiving, from the first AU, scheduling information comprising information on the first user layers K₁ to be transmitted in a time transmission interval, TTI, by the first RU; and
when receiving, from the first AU, the DL data streams of the first user layer K₁ and the first part of BFW W_{BBU,1} that are scheduled to the first RU, the DL data streams of the first user layers K₁ and the first part of BFW W_{BBU,1} that are scheduled to the first RU comprises the DL data streams of the first and second user layers K₁, K₂ and the first part of BFW W_{BBU} that are scheduled to the first and second RU, and selecting, for the determining and the beamforming, only the DL data streams of the first user layers K₁ and the first part of BFW W_{BBU,1} that are scheduled to the first RU based on the received scheduling information.

9. A method performed by a first aggregation unit, AU, of a distributed base station system, the distributed base station system further comprising a first RU comprising N₁ antennas, the first RU being connected to the first AU via a first AU FH link and a second RU comprising N₂ antennas, the second RU being connected to the first AU via a second AU FH link, the distributed base station system further comprising a BBU connected to the first AU over a first BBU FH link, the method comprising:
receiving, from the first RU over the first AU FH link, at least a part of first intermediate BFW C₁ determined to be used for centralized interference mitigation based on a first DL channel estimate Ĥ₁ of a communication channel between the first RU and a first number of UEs;
receiving, from the second RU over the second AU FH link, at least a part of second intermediate BFW C₂ determined to be used for centralized interference mitigation based on a second DL channel estimate Ĥ₂ of a communication channel between the second RU and a second number of UEs;
combining the at least part of first intermediate BFW C₁ with the at least part of second intermediate BFW C₂ into combined intermediate BFW C_{com};
sending, to the BBU over the first BBU FH link, the combined intermediate BFW C_{com}; and one of:
receiving, from the BBU, intermediately-beamformed DL data streams of first user layers K₁ of the first number of UEs and of second user layers K₂ of the second number of UEs, the DL data streams being intermediately beamformed based on an inverse calculation of at least the combined intermediate BFW C_{com}, sending at least the intermediately-beamformed DL data streams of the first user layers to the first RU and sending at least the intermediately-beamformed DL data streams of the second user layers to the second RU, and
receiving, from the BBU, the DL data streams of the first and second user layers K₁, K₂, and at least a part of first part of BFW W_{BBU} determined based on an inverse calculation of at least the combined intermediate BFW C_{com}, sending to the first RU, at least the DL data streams of the first user layers K₁ and at least the first part of BFW W_{BBU,1} that are scheduled to the first RU and sending to the second RU, at least the DL data streams of the second user layers K₂ and at least the first part of BFW W_{BBU,2} that are scheduled to the second RU.

10. The method of claim 9, further comprising:
receiving, from the BBU, scheduling information comprising information on the first user layers K₁ to be transmitted in a TTI by the first RU and on the second user layers K₂ to be transmitted in the TTI by the second RU; and
sending the received scheduling information to the first RU and the second RU, wherein the sending of at least the intermediately-beamformed DL data streams of the first user layers to the first RU and the sending of at least the intermediately-beamformed DL data streams of the second user layers to the second RU comprises sending the first and the second intermediately-beamformed DL data streams of the first and the second user layers to both the first and the second RU.

11. The method of claim 9, further comprising:
receiving, from the BBU, scheduling information comprising information on the first user layers K₁ to be transmitted in a TTI by the first RU and on the second user layers K₂ to be transmitted in the TTI by the second RU; and
extracting the intermediately-beamformed DL data streams of the first user layers K₁ and the intermediately-beamformed DL data streams of the second user layers K₂, wherein the sending of at least the intermediately-beamformed DL data streams of the first user layers to the first RU comprises sending only the extracted intermediately-beamformed DL data streams of the first user layers K₁ to the first RU, and the sending of at least the intermediately-beamformed DL data streams of the second user layers to the second RU comprises sending only the extracted intermediately-beamformed DL data streams of the second user layers K₂ to the second RU.

12. The method of claim 9, wherein the at least part of first intermediate BFW C₁ that are received from the first RU comprises only a subset of the first intermediate BFW C₁, and the at least part of second intermediate BFW C₂ that are received from the second RU comprises only a subset of the second intermediate BFW C₂, and wherein the combining of the at least one first intermediate BFW C₁ with the at least one second intermediate BFW C₂ into combined intermediate BFW C_{com} comprises combining the subset of the first intermediate BFW with the subset of the second intermediate BFW and wherein the sending of the combined intermediate BFW C_{com} comprises sending the combination of the subset of the first intermediate BFW with the subset of the second intermediate BFW to the BBU.

13. The method of claim 2, wherein the at least a part of first part of BFW W_{BBU} that are received from the BBU comprises only a subset of the first part of BFW W_{BBU}, and the method further comprises recovering the whole first part of BFW from the subset of the first part of BFW W_{BBU} based on Hermitian symmetry property of the first part of BFW W_{BBU}.

14. The method of claim 2, wherein the distributed base station system further comprises a cascade-coupled AU connected to the first AU via an AU-AU FH link, the cascade-coupled AU being also connected to one or more other RUs from which it receives intermediate BFW determined by respective ones of the one or more other RUs, the method further comprises:
receiving, from the cascade-coupled AU over the AU-AU FH link, other combined intermediate BFW that the cascade-coupled AU has combined based on the intermediate BFW it has received from its one or more other Rus, wherein the combining of intermediate BFW further comprises also combining the received other combined intermediate BFW with the at least part of first and the at least part of second intermediate BFW into the combined intermediate BFW that are sent to the BBU.

15. A method performed by a baseband unit, BBU, system of a wireless communication system, the wireless communication system comprising a distributed base station system, the distributed base station system comprising a BBU, a first aggregation unit, AU, connected to the BBU over a first BBU FH link, a first RU comprising N₁ antennas, the first RU being connected to the first AU via a first AU FH link, and a second RU comprising N₂ antennas, the second RU being connected to the first AU via a second AU FH link, the method comprising:
receiving, from the first AU, combined intermediate BFW C_{com} comprising at least part of first intermediate BFW C₁ combined with at least part of second intermediate BFW C₂, the at least part of first intermediate BFW C₁ originating from the first RU and being determined to be used for centralized interference mitigation based on a first DL channel estimate Ĥ₁ of a communication channel between the first RU and a first number of UEs, the at least part of second intermediate BFW C₂ originating from the second RU and being determined to be used for centralized interference mitigation based on a second DL channel estimate Ĥ₂ of a communication channel between the second RU and a second number of UEs;
sending, to the first AU, scheduling information comprising information on first user layers K₁ of the first number of UEs to be transmitted in a time transmission interval, TTI, by the first RU and information on second user layers K₂ of the second number of UEs to be transmitted in the TTI by the second RU;
determining first part of BFW W_{BBU} based on an inverse calculation of at least the received combined intermediate BFW C_{com}; and one of:
performing an intermediate beamforming on DL data streams of the first and second user layers K₁, K₂, based on the first part of BFW W_{BBU}, and sending the intermediately-beamformed DL data streams of the first and second user layers K₁, K₂ to the first AU, and
sending, to the first AU, at least a part of the determined first part of BFW W_{BBU} and the DL data streams of the first and second user layers K₁, K₂.

16. The method of claim 15, wherein the combined intermediate BFW C_{com} are received as only a subset of the combined intermediate BFW, and the method further comprises recovering the combined intermediate BFW from the subset based on Hermitian symmetry property of the combined intermediate BFW C_{com}.

17. The method of claim 15, wherein the at least a part of the first part of BFW W_{BBU} that is sent to the first AU comprises only a subset of the first part of BFW W_{BBU}.

18. The method of claim 15, wherein the determining of first part of BFW W_{BBU} is also based on interference experienced at neighboring cells, so that the first part of BFW is calculated as the inverse of the combined intermediate BFW added with a factor based on the experienced interference.

19. The method of claim 18, wherein the factor is a regularization term δ₂I where I is an identity matrix and δ₂ is a regularization factor that is based on an estimate of power of interference and noise.

20. The method of claim 15, wherein the distributed base station system further comprises a second AU connected to the BBU via a second BBU FH link, the second AU being also connected to one or more second AU RUs, the method further comprising:
receiving, from the second AU, second AU intermediate BFW originating from the one or more second AU RUs and being determined to be used for centralized interference mitigation based on DL channel estimates of communication channels between the one or more second AU RUs and a third number of UEs connected to the one or more second AU RUs; and
combining the combined intermediate BFW received from the first AU with the second AU intermediate BFW received from the second AU into finally combined intermediate BFW, and wherein the determining of the first part of BFW W_{BBU} is based on an inverse calculation of at least the finally combined intermediate BFW.

21-28. (canceled)

29. A first aggregation unit, AU, configured to operate in a distributed base station system, the distributed base station system further comprising a first RU comprising N₁ antennas, the first RU being connected to the first AU via a first AU fronthaul, FH, link and a second RU comprising N₂ antennas, the second RU being connected to the first AU via a second AU FH link, the distributed base station system further comprising a baseband unit, BBU, connected to the first AU over a first BBU FH link, the first AU comprising a processing circuitry and a memory, said memory containing instructions executable by said processing circuitry, whereby the first AU is operative for:
receiving, from the first RU over the first AU FH link, at least a part of first intermediate BFW C₁ determined to be used for centralized interference mitigation based on a first DL channel estimate Ĥ₁ of a communication channel between the first RU and a first number of UEs;
receiving, from the second RU over the second AU FH link, at least a part of second intermediate BFW C₂ determined to be used for centralized interference mitigation based on a second DL channel estimate Ĥ₂ of a communication channel between the second RU and a second number of UEs;
combining the at least part of first intermediate BFW C₁ with the at least part of second intermediate BFW C₂ into combined intermediate BFW C_{com};
sending, to the BBU over the first BBU FH link, the combined intermediate BFW C_{com};
receiving, from the BBU, intermediately-beamformed DL data streams of first user layers K₁ of the first number of UEs and of second user layers K₂ of the second number of UEs, the DL data streams being intermediately beamformed based on an inverse calculation of at least the combined intermediate BFW C_{com}, sending at least the intermediately-beamformed DL data streams of the first user layers to the first RU and sending at least the intermediately-beamformed DL data streams of the second user layers to the second RU; or
receiving, from the BBU, the DL data streams of the first and second user layers K₁, K₂, and at least a part of first part of BFW W_{BBU} determined based on an inverse calculation of at least the combined intermediate BFW C_{com}, sending to the first RU, at least the DL data streams of the first user layers K₁ and at least the first part of BFW W_{BBU,1} that are scheduled to the first RU and sending to the second RU, at least the DL data streams of the second user layers K₂ and at least the first part of BFW W_{BBU,2} that are scheduled to the second RU.

30-46. (canceled)
